(19) United States
(12) Patent Application Publication
(10) Pub. No.: US 2010/0031914 A1
(43) Pub. Date: Feb. 11, 2010

(54) HOLLOW MEMBER, CYLINDER SLEEVE AND METHODS FOR PRODUCING THEM

(75) Inventors: Tomonori Fukumoto, Utsunomiya-shi (JP); Yukio Iijima, Sakado-shi (JP); Takaharu Echigo, Haga-gun (JP); Kazuaki Yamagami, Utsunomiya-shi (JP); Haruki Kodama, Nikko-shi (JP); Yuji Imamaru, Kawachi-gun (JP); Yutaka Kashihara, Utsunomiya-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD, Minato-ku (JP)

(21) Appl. No.: 12/529,318

(22) PCT Filed: Mar. 10, 2008
(86) PCT No.: PCT/JP2008/054304

§ 371 Date: Aug. 31, 2009

(30) Foreign Application Priority Data
Mar. 15, 2007 (JP) 2007-066221
Mar. 15, 2007 (JP) 2007-066223
Mar. 15, 2007 (JP) 2007-066224
Mar. 15, 2007 (JP) 2007-066227

(51) Int. Cl. F02F 1/00; B23P 11/00

(52) U.S. Cl. 123/193.2; 29/888.06

(57) ABSTRACT

The tubular die of a centrifugal casting device of GNo.30 or above is employed suitably and powder is introduced while rotating, and an outer tubular body composed of that powder is provided. Subsequently, molten is introduced to the inner circumferential wall side of the outer tubular body while sustaining rotation of the tubular die thus forming an inner tubular body. The outer tubular body functions as a cooling metal (chiller) when the molten is cooled and solidified. In place of the outer tubular body composed of the powder, molten may be used for forming an outer tubular body or an outer tubular molding molded previously into tubular shape may be employed.

### TECHNICAL FIELD

The present invention relates to a substantially cylindrical hollow member, a cylinder sleeve, and a producing method thereof.

### BACKGROUND ART

A cylinder sleeve can be disposed in a cylinder bore of an internal combustion engine for driving an automobile. A piston is reciprocated in the cylinder bore, and a side peripheral wall of the piston is slidably in contact with an inner peripheral wall of the cylinder sleeve. In recent years, aluminum alloys, particularly Al—Si alloys have been increasingly used as a material of the cylinder sleeve because the alloys are lightweight, highly abrasion resistant, and highly strong.

The cylinder sleeve may be produced by a so-called centrifugal casting method as described in Patent Document 1. In this case, a melt is introduced into a rotating cylindrical mold, and the melt is distributed on an inner peripheral wall of the cylindrical mold due to a centrifugal force, to form a cylindrical body. The cylindrical melt is solidified by cooling, and the obtained preform is subjected to machining such as shaving, to obtain a cylindrical product of the cylinder sleeve. A concavo-convex shape of a coated surface on the inner wall of the cylindrical mold is transferred to an outer peripheral wall of the cylinder sleeve, whereby a so-called spiny is formed on the cylinder sleeve.

A cylinder block may be formed by placing the cylinder sleeve in a predetermined position in a mold, adding a melt in the mold, and cooling and solidifying the melt (i.e., by casting). The cast cylinder block is cast around the cylinder sleeve. The bonding strength between the cylinder block and the cylinder sleeve is improved by an anchor on the outer peripheral wall of the cylinder sleeve, such as the spiny, an irregularity (e.g. a groove line) formed by the machining such as shaving, or a concavo-convex shape formed by a shot blasting treatment.

In the case of using a melt of an Al—Si alloy for producing the cylinder sleeve by the centrifugal casting method as described in Patent Document 1, primary crystal Si grains are unevenly distributed, and a larger amount of the grains is present around the outer peripheral wall than around the radially intermediate portion in the preform. Thus, when the inner peripheral wall of the preform is shaved, the inner peripheral wall of the resultant cylinder sleeve, with which the piston is slidably in contact, has low primary crystal Si content. In other words, in the case of producing the cylinder sleeve of the Al—Si alloy by the centrifugal casting method, the Si composition ratio of the cylinder sleeve cannot be easily controlled, whereby it is difficult to obtain desired properties.

Improvement of the metal structure, specifically size reduction of the primary crystal Si grains generated in solidifying the Al—Si alloy melt, has been studied in view of increasing the strength of the cylinder sleeve while maintaining a sufficient toughness. However, to achieve the size reduction of the primary crystal Si grains, it is necessary to optimize the casting conditions such as the cylindrical mold rotation speed and temperature in the centrifugal casting method. Thus, a trial and error process is required to optimize the casting conditions. Further, it is necessary to strictly regulate the optimized casting conditions in mass production.

Aluminum and alloys thereof have been increasingly used as a material of the cylinder block which is cast around the cylinder sleeve. However, the melt for forming the cylinder block has a composition excellent in fluidity so as to carry out the casting process smoothly, while the melt for forming the cylinder sleeve has a composition excellent in abrasion resistance. Thus, the composition of the melt for forming the cylinder block does not always correspond with that of the melt for forming the cylinder sleeve. When the melts have different compositions, the cylinder block and the cylinder sleeve have different linear expansion coefficients.

When the linear expansion coefficient difference is remarkably large, the bonding strength between the cylinder block and the cylinder sleeve is often insufficient regardless of the anchor effect of the spiny generated in cooling and solidifying the melt. In a method proposed in Patent Document 2, the bonding strength is improved by forming a protrusion larger than the spiny on the outer peripheral wall of the cylinder sleeve. Further, the bonding strength can be improved by coating the outer peripheral wall of the cylinder sleeve with a low-melting alloy as described in Patent Document 3.

However, methods for dispersing the primary crystal Si grains substantially uniformly in the cylinder sleeve and for reducing the grain size of the primary crystal Si are not disclosed in Patent Document 2 and Patent Document 3. Further, there is a demand for a method for improving the bonding strength between the cylinder sleeve and the cylinder block, simpler than the methods disclosed in the patent documents.

Patent Document 1: Japanese Patent Publication No. 52-027608

Patent Document 2: Japanese Patent No. 3866636

Patent Document 3: Japanese Laid-Open Patent Publication No. 2006-043708

### DISCLOSURE OF THE INVENTION

A general object of the present invention is to provide a hollow member having a controlled composition ratio of each element.

A principal object of the present invention is to provide a hollow member containing primary crystal Si grains with reduced size.

Another object of the present invention is to provide a cylinder sleeve that can be easily connected to a cylinder block.

A further object of the present invention is to provide a cylinder sleeve having an inner peripheral wall excellent in abrasion resistance.

A still further object of the present invention is to provide a method for producing a hollow member that can be carried out simply without strict regulation of casting conditions.

A still further object of the present invention is to provide a method for producing a cylinder sleeve in which fine primary crystal Si grains are substantially uniformly dispersed.

According to an aspect of the present invention, there is provided a substantially cylindrical, stack-type, hollow member comprising an outer cylindrical body and an inner cylindrical body connected to an inner peripheral wall thereof, wherein the outer cylindrical body is formed by fusing a powder of aluminum or an aluminum alloy, and the inner cylindrical body is composed of an Al—Si alloy.

In this aspect, the inner cylindrical body is formed by centrifugally casting a melt as described hereinafter. In the centrifugal casting, the outer cylindrical body acts as a cooling metal (a chiller) to increase the rate of cooling the melt. Thus, fine primary crystal Si grains are distributed substantially uniformly in the diameter direction of the inner cylindrical body. In other words, the fine primary crystal Si grains are uniformly dispersed in the inner cylindrical body of the hollow member. Therefore, the inner cylindrical body has substantially constant properties in different portions.

The hollow member may be thinned by shaving the inner peripheral wall (the inner cylindrical body) to produce a cylinder sleeve. The resultant product can exhibit a sufficient abrasion resistance or the like even in this case, since the primary crystal Si grains are dispersed substantially uniformly.

Preferred examples of the aluminum alloys for forming the outer cylindrical body include Al—Si alloys. The composition of the Al—Si alloy for forming the outer cylindrical body may be the same as or different from that of the Al—Si alloy for forming the inner cylindrical body. For example, the outer cylindrical body comprises an Al-12% Si alloy (by mass, also the following composition ratio values are in percent by mass), while the inner cylindrical body comprises an Al-23% Si alloy.

According to another aspect of the present invention, there is provided a method for producing a substantially cylindrical, stack-type, hollow member by centrifugal casting by supplying a melt into a cylindrical mold rotating, comprising the steps of: introducing a powder of aluminum or an aluminum alloy into the rotating cylindrical mold to form an outer cylindrical body; and introducing the melt of an Al—Si alloy onto an inner peripheral wall of the outer cylindrical body, thereby fusing the powder and forming an inner cylindrical body of the melt, to produce a hollow member containing a stack of the outer cylindrical body and the inner cylindrical body connected to the inner peripheral wall thereof.

In this aspect, first the outer cylindrical body is formed using the powder, and then the inner cylindrical body is formed by the centrifugal casting inside the outer cylindrical body. The outer cylindrical body acts as a chiller to increase the rate of cooling the melt. Thus, the melt is solidified before primary crystal Si grains grow larger or move closer to the outer cylindrical body. As a result, the inner cylindrical body has a structure in which fine primary crystal Si grains are substantially uniformly dispersed.

Further, in this aspect, a melt is not used as a material for forming the outer cylindrical body, whereby processes and furnaces for melting the powder are not required. Thus, the increase of costs and equipments for melting the powder can be prevented, and the hollow member can be produced with reduced costs.

When the powder for forming the outer cylindrical body is introduced into the cylindrical mold, the cylindrical mold is preferably rotated at a G number (G No.) of 30 or more. In this case, the powder is pressed due to a centrifugal force onto the inner peripheral wall of the cylindrical mold without falling, so that the outer cylindrical body can be reliably formed.

Preferred examples of the aluminum alloys for forming the outer cylindrical body include Al—Si alloys as described above.

According to a further aspect of the present invention, there is provided a substantially cylindrical, stack-type, hollow member comprising an outer cylindrical body and an inner cylindrical body disposed in this order from the outside, wherein the inner cylindrical body and the outer cylindrical body are composed of the same types of Al—Si alloys.

In the present invention, the term “the same types of alloys” means that the alloys are classified into the same casting alloy group in a standard such as Japanese Industrial Standards (JIS). For example, in this aspect, when the inner cylindrical body comprises an AC9A equivalent material (an aluminum alloy according to JIS), the outer cylindrical body also comprises an AC9A equivalent material. In this case, the compositions of the equivalent materials do not have to be strictly the same. The AC9A equivalent material is an aluminum alloy containing 22% to 24% by mass of Si. For example, an AC9A equivalent material containing 22% by mass of Si and an AC9A equivalent material containing 24% by mass of Si may be used for the inner cylindrical body and the outer cylindrical body respectively.

In this aspect, the outer cylindrical body is formed by centrifugal casting, and the inner cylindrical body is formed by centrifugal casting inside the outer cylindrical body, as described hereinafter. In the centrifugal casting, the outer cylindrical body acts as a cooling metal (a chiller) to increase the rate of cooling the melt. Thus, fine primary crystal Si grains are distributed substantially uniformly in the diameter direction of the inner cylindrical body. In other words, the fine primary crystal Si grains are uniformly dispersed in the inner cylindrical body of the hollow member. Therefore, the inner cylindrical body has substantially constant properties in different portions.

The hollow member may be thinned by shaving the inner peripheral wall (on the side of the inner cylindrical body). The resultant product can exhibit a sufficient abrasion resistance or the like even in this case, since the primary crystal Si grains are dispersed substantially uniformly.

The primary crystal Si grains in the metal structure of the inner cylindrical body preferably have an average diameter of 35 μm or less. In this case, the resultant hollow member can be excellent not only in abrasion resistance but also in strength.

According to a still further aspect of the present invention, there is provided a method for producing a substantially cylindrical, stack-type, hollow member by centrifugal casting by supplying a melt into a cylindrical mold rotating, comprising the steps of: introducing a melt of an Al—Si alloy into a cylindrical mold rotating, thereby forming an outer cylindrical body by centrifugal casting; and introducing a melt of the same type of an Al—Si alloy into the outer cylindrical body while rotating the cylindrical mold, thereby forming an inner cylindrical body by centrifugal casting, to prepare a stacked preform.

In this aspect, the outer cylindrical body acts as a chiller to increase the rate of cooling the melt for forming the inner cylindrical body. Thus, the melt is solidified before primary crystal Si grains grow larger or move closer to the outer cylindrical body. As a result, the inner cylindrical body has a structure in which fine primary crystal Si grains are substantially uniformly dispersed.

Further, the hollow member can be produced only by the simple procedure of adding the same types of the melts to the cylindrical mold twice, so that the increase of the production costs can be prevented. Thus, the hollow member can be produced with reduced costs.

In this aspect, it is preferred that the outer cylindrical body has a thickness of 0.5 to 2.0 mm, and the melt for forming the inner cylindrical body is introduced after the temperature of the outer cylindrical body is lowered to a liquidus-solidus temperature of a phase diagram or less. In this case, the average diameter of the primary crystal Si grains can be reduced to 35 μm or less.

According to a still further aspect of the present invention, there is provided a substantially cylindrical, stack-type, hollow member comprising an inner cylindrical cast body and an outer cylindrical formed body disposed in this order from the inside, wherein the inner cylindrical cast body comprises aluminum or an aluminum alloy, and the outer cylindrical formed body is composed of an Al—Si alloy.

In this aspect, the outer cylindrical formed body is inserted into a cylindrical mold of a centrifugal casting machine in advance, and the inner cylindrical cast body is formed by centrifugal casting inside the outer cylindrical formed body as described hereinafter. In the centrifugal casting, the outer cylindrical formed body acts as a cooling metal (a chiller) to increase the rate of cooling the melt. Thus, fine primary crystal Si grains are distributed substantially uniformly in the diameter direction of the inner cylindrical cast body. In other words, the fine primary crystal Si grains are uniformly dispersed in the inner cylindrical cast body of the hollow member. Therefore, the inner cylindrical cast body has substantially constant properties in different portions.

The hollow member may be thinned by shaving the inner peripheral wall (on the side of the inner cylindrical cast body). The resultant product can exhibit a sufficient abrasion resistance or the like even in this case, since the primary crystal Si grains are dispersed substantially uniformly.

The primary crystal Si grains in the metal structure of the inner cylindrical cast body preferably have an average diameter of 35 μm or less. In this case, the resultant hollow member can be excellent not only in abrasion resistance but also in strength.

According to a still further aspect of the present invention, there is provided a method for producing a hollow member containing a stack of an inner cylindrical cast body and an outer cylindrical formed body disposed in this order from the inside, comprising the steps of: inserting a cylinder of aluminum or an aluminum alloy for forming the outer cylindrical formed body into a cylindrical mold of a centrifugal casting machine; and introducing a melt of an Al—Si alloy into the cylindrical mold while the cylindrical mold is rotating, thereby forming the inner cylindrical cast body by centrifugal casting, to prepare a stacked preform.

In this aspect, the outer cylindrical formed body acts as a chiller to increase the rate of cooling the melt for forming the inner cylindrical cast body. Thus, the melt is solidified before primary crystal Si grains grow larger or move closer to the outer cylindrical formed body. As a result, the inner cylindrical cast body has a structure in which fine primary crystal Si grains are substantially uniformly dispersed.

Further, the hollow member can be produced only by the simple procedure of inserting the formed body (the outer cylindrical formed body) into the cylindrical mold and adding the Al—Si alloy melt into the cylindrical mold, so that the increase of the production costs can be prevented. Thus, the hollow member can be produced with reduced costs.

In this aspect, the outer cylindrical formed body preferably has a thickness of 1.0 to 2.0 mm. In this case, the average diameter of the primary crystal Si grains can be reduced to 35 μm or less, and further the grain size distribution width thereof can be reduced.

In the above aspects, preferred examples of the hollow members include cylinder sleeves to be disposed in a bore of a cylinder block of an internal combustion engine. The cylinder sleeve may be produced by shaving the inner peripheral wall of the preform.

According to a still further aspect of the present invention, there is provided a cylinder sleeve to be disposed in a bore of a cylinder block of an internal combustion engine, comprising an outer cylindrical body and an inner cylindrical body disposed in this order from the outside, wherein the inner cylindrical body and the outer cylindrical body comprise different types of Al—Si alloys.

In this cylinder sleeve, the outer periphery and the inner periphery comprise the different materials, and thereby are different in properties. Therefore, the cylinder sleeve can be suitably used when the outer periphery and the inner periphery are required to have different properties.

Specifically, the inner peripheral wall of the cylinder sleeve has to be excellent in abrasion resistance because a piston is brought slidably into contact with the inner peripheral wall. Thus, the Al—Si alloy for the inner cylindrical body is preferably more abrasion-resistant than the Al—Si alloy for the outer cylindrical body.

The linear expansion coefficient difference between the Al—Si alloy of the outer cylindrical body and a material of the cylinder block is preferably 3×10⁻⁶/° C. or less. When the materials of the cylinder block and the outer cylindrical body have similar linear expansion coefficients as above, a sufficient bonding strength can be easily obtained between the cylinder sleeve and the cylinder block.

A concavo-convex shape is preferably formed on the outer peripheral wall of the outer cylindrical body. A so-called anchor effect can be obtained due to the concavo-convex shape, so that the bonding strength can be further improved.

According to a still further aspect of the present invention, there is provided a method for producing a cylinder sleeve to be disposed in a bore of a cylinder block of an internal combustion engine, comprising the steps of: introducing a first melt of an Al—Si alloy into a cylindrical mold rotatable, thereby forming an inner cylindrical body by centrifugal casting; introducing a second melt of another type of Al—Si alloy into the first layer while rotating the cylindrical mold, thereby forming an outer cylindrical body by centrifugal casting, to prepare a stacked preform; and shaving an inner peripheral wall of the preform.

In the cylinder sleeve produced by the above steps, the inner periphery and the outer periphery can have different properties.

In this aspect, the outer cylindrical body acts as a cooling metal (a chiller) to increase the rate of cooling the second melt for forming the inner cylindrical body. Thus, the melt is solidified before primary crystal Si grains grow larger or move closer to the outer cylindrical body. As a result, the inner cylindrical body has a structure in which fine primary crystal Si grains are substantially uniformly dispersed.

Further, in this aspect, the cylinder sleeve having the outer periphery and the inner periphery with different properties can be easily produced only by the remarkably simple procedure of using the different types of melts in the centrifugal casting.

A cylinder sleeve having an inner peripheral wall with a high abrasion resistance can be obtained when the Al—Si alloy of the second melt is more abrasion-resistant than that of the first melt.

Further, a sufficient bonding strength can be obtained between the cylinder sleeve and the cylinder block when the linear expansion coefficient difference between the cylinder sleeve formed of the first melt and a material of the cylinder block is 3×10⁻⁶/° C. or less.

### BRIEF DESCRIPTION OF THE DRAWINGS

FIG. 1 is an overall, schematic, perspective view showing a hollow member according to an embodiment of the present invention;

FIG. 2 is a schematic, structural view showing a principal part of a centrifugal casting machine for producing the hollow member of FIG. 1;

FIG. 3 is a longitudinal, cross-sectional, explanatory view showing formation of an outer cylindrical body using the centrifugal casting machine of FIG. 2;

FIG. 4 is a diametrically cross-sectional, explanatory view showing the outer cylindrical body formed in the centrifugal casting machine;

FIG. 5 is a longitudinal, cross-sectional, explanatory view showing formation of an inner cylindrical body using the centrifugal casting machine of FIG. 2;

FIG. 6 is a diametrically cross-sectional, explanatory view showing the inner cylindrical body formed in the centrifugal casting machine;

FIG. 7 is an overall, schematic, perspective view showing a preform for forming a cylinder sleeve according to another embodiment of the present invention;

FIG. 8 is a schematic, structural view showing a principal part of a centrifugal casting machine for producing the preform of FIG. 7;

FIG. 9 is a longitudinal, cross-sectional, explanatory view showing formation of an outer cylindrical body using the centrifugal casting machine of FIG. 8;

FIG. 10 is a diametrically cross-sectional, explanatory view showing the outer cylindrical body formed in the centrifugal casting machine;

FIG. 11 is a longitudinal, cross-sectional, explanatory view showing formation of an inner cylindrical body using the centrifugal casting machine of FIG. 8;

FIG. 12 is a diametrically cross-sectional, explanatory view showing the inner cylindrical body formed in the centrifugal casting machine;

FIG. 13 is a schematic, structural view showing a principal part of another centrifugal casting machine;

FIG. 14 is a partly vertical-cross-sectional, schematic, structural, explanatory view showing a principal part of a melt filling pipe and a melt storage furnace of the centrifugal casting machine of FIG. 13;

FIG. 15 is a cross-sectional, explanatory view showing introduction of a melt to a cylindrical mold of the centrifugal casting machine of FIG. 13 in the longitudinal direction of the cylindrical mold;

FIG. 16 is a cross-sectional, explanatory view showing heating of an inner peripheral wall of a cylindrical body by a rod heater in the longitudinal direction of the cylindrical mold;

FIG. 17 is an overall, schematic, perspective view showing a preform for forming a cylinder sleeve according to a further embodiment of the present invention;

FIG. 18 is a schematic, structural view showing a principal part of a centrifugal casting machine for producing the preform of FIG. 17;

FIG. 19 is a diametrically cross-sectional, explanatory view showing an outer cylindrical formed body inserted in a cylindrical mold of the centrifugal casting machine of FIG. 18;

FIG. 20 is a longitudinal, cross-sectional, explanatory view showing formation of an inner cylindrical cast body using the centrifugal casting machine of FIG. 18;

FIG. 21 is a diametrically cross-sectional, explanatory view showing an inner cylindrical cast body formed in the centrifugal casting machine;

FIG. 22 is an overall, schematic, perspective view showing a preform for forming a cylinder sleeve according to a still further embodiment of the present invention;

FIG. 23 is a schematic, structural view showing a principal part of a centrifugal casting machine for producing the preform of FIG. 22;

FIG. 24 is a longitudinal, cross-sectional, explanatory view showing formation of an outer cylindrical body using the centrifugal casting machine of FIG. 23;

FIG. 25 is a diametrically cross-sectional, explanatory view showing the outer cylindrical body formed in the centrifugal casting machine;

FIG. 26 is a longitudinal, cross-sectional, explanatory view showing formation of an inner cylindrical body using the centrifugal casting machine of FIG. 23;

FIG. 27 is a diametrically cross-sectional, explanatory view showing the inner cylindrical body formed in the centrifugal casting machine;

FIG. 28 is a schematic, structural view showing a principal part of another centrifugal casting machine;

FIG. 29 is a partly vertical-cross-sectional, schematic, structural, explanatory view showing a principal part of a melt filling pipe and a melt storage furnace of the centrifugal casting machine of FIG. 28;

FIG. 30 is a cross-sectional, explanatory view showing the state where introduction of a melt to a cylindrical mold of the centrifugal casting machine of FIG. 28 starts in the longitudinal direction of the cylindrical mold; and

FIG. 31 is a cross-sectional, explanatory view showing heating of an inner peripheral wall of a cylindrical body by a rod heater in the longitudinal direction of the cylindrical mold.

### BEST MODE FOR CARRYING OUT THE INVENTION

A plurality of preferred embodiments of the hollow member and the producing method of the present invention will be described in detail below with reference to attached drawings.

A first embodiment will be described below. In the first embodiment, a powder is used to form a cylindrical body, and a melt is added inside the cylindrical body to form a cylindrical cast body.

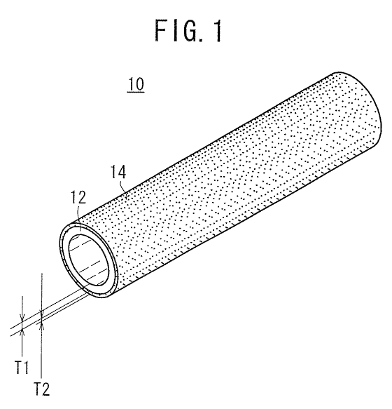

FIG. 1 is an overall, schematic, perspective view of a hollow member 10 according to the first embodiment. The hollow member 10 is a stack of an inner cylindrical body 12 and an outer cylindrical body 14.

In this embodiment, the inner cylindrical body 12 is a cast body composed of an Al-23% Si alloy. The inner cylindrical body 12 is formed by cooling and solidifying a melt as described hereinafter. The inner cylindrical body 12 has a thickness T1 of about 5 to 6 mm.

In the inner cylindrical body 12, fine primary crystal Si grains having an average diameter of 35 μm or less are not unevenly distributed around the outer peripheral wall (in the vicinity of the outer cylindrical body 14), and are dispersed substantially uniformly in the diameter direction. Further, the primary crystal Si grains have a small grain size distribution width. In other words, the fine primary crystal Si grains having approximately equal sizes are uniformly dispersed in the structure of the inner cylindrical body 12.

On the other hand, the outer cylindrical body 14 is formed by fusing powder particles of an Al-12% Si alloy to each other. The inner peripheral wall of the outer cylindrical body 14 is connected to the outer peripheral wall of the inner cylindrical body 12. The outer cylindrical body 14 preferably has a thickness T2 of 0.5 to 2 mm.

The inner peripheral wall (i.e. the inner cylindrical body 12) of the hollow member 10 is shaved to produce a cylinder sleeve. In other words, the inner cylindrical body 12 is thinned into a predetermined thickness. Thus, the inner cylindrical body 12 is formed as a machining margin of the hollow member 10.

As described above, the fine primary crystal Si grains having approximately equal sizes are dispersed uniformly in the diameter direction in the inner cylindrical body 12. Therefore, the inner peripheral wall of the machined hollow member 10 (the cylinder sleeve), with which a piston is slidably brought into contact, has an excellent abrasion resistance. Further, the machined hollow member 10 exhibits a high strength over all. Thus, an internal combustion engine containing the cylinder sleeve is excellent in durability.

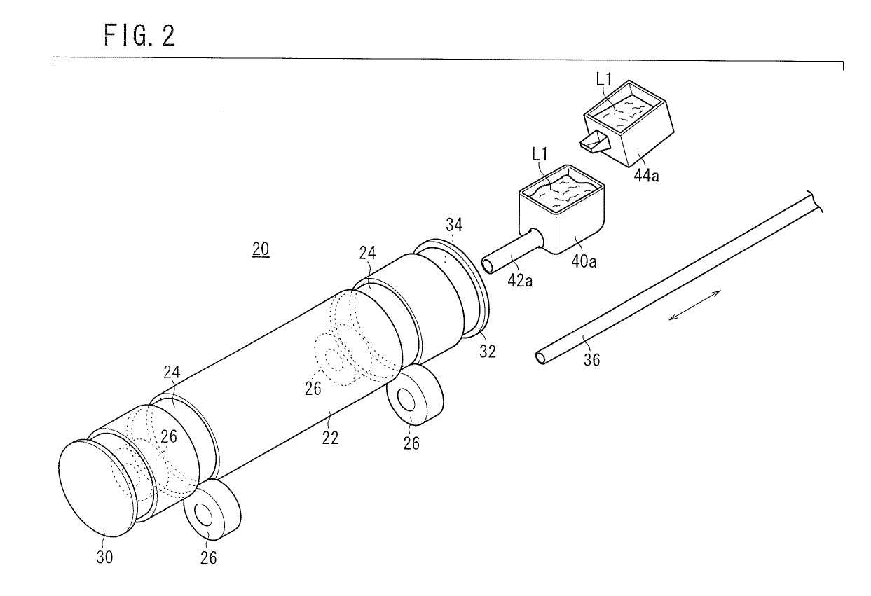

A method for producing the hollow member 10 using a centrifugal casting machine 20 shown in FIG. 2 will be described below.

The centrifugal casting machine 20 contains a cylindrical mold 22 lying approximately horizontally. Two annular grooves 24, 24 are formed on the outer peripheral wall of the cylindrical mold 22 such that the outer peripheral wall is notched along the circumferential direction. The outer peripheral walls of a pair of rollers 26, 26 are slidably in contact with the bottom of each annular groove 24. Thus, the cylindrical mold 22 is supported by two pairs of the rollers.

The four rollers 26 are connected to a rotary drive source (not shown). Each of the rollers 26 is rotated by the rotary drive source, whereby the cylindrical mold 22 is rotated.

A discotic closing member 30 is fitted into one end of the cylindrical mold 22, and an annular frame 32 is attached to the other end. The annular frame 32 is opened to form a through hole 34, and a powder feeder 36 or a melt filling pipe 42a of a trough 40a is inserted from the through hole 34 into the cylindrical mold 22.

The powder feeder 36 extends from a powder reservoir (not shown). The powder reservoir can be displaced by a displacement mechanism (not shown), and the powder feeder 36 can be moved to or from the cylindrical mold 22 according to this displacement. The powder of the Al-12% Si alloy, as the material for the outer cylindrical body 14, is stored in the powder reservoir.

A melt L1 for forming the inner cylindrical body 12 is contained in the main body of the trough 40a. A tiltable pot 44a is disposed in the vicinity of the trough 40a, and the melt L1 is introduced from the pot 44a to the trough 40a.

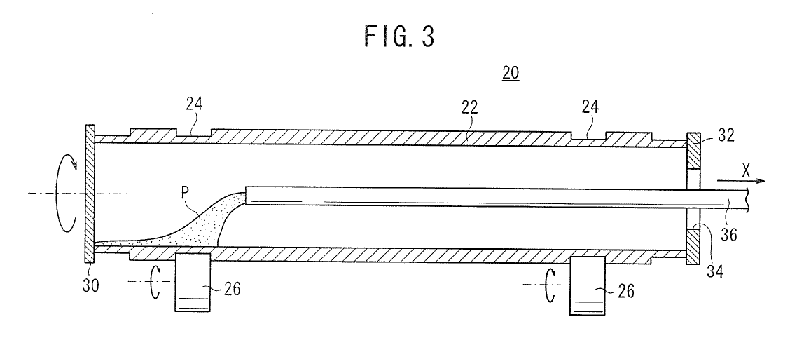

In the production of the hollow member 10, a coating material is applied to the inner peripheral wall of the cylindrical mold 22, and then the powder feeder 36 is inserted from the through hole 34 into the cylindrical mold 22. In this step, as shown in FIG. 3, the end of the powder feeder 36 is positioned in the vicinity of the discotic closing member 30. Though the melt filling pipe 42a of the trough 40a is not shown in FIG. 3, the melt filling pipe 42a may be positioned such that it does not interfere the powder feeder 36.

The rollers 26 are rotated in this state, whereby the cylindrical mold 22 is rotated. Then, the powder P of the Al-12% Si alloy is introduced from the powder feeder 36 into the cylindrical mold 22.

In this step, the cylindrical mold 22 is preferably rotated at a G No. of 30 or more. The powder P is pressed to the inner peripheral wall of the cylindrical mold 22 due to a centrifugal force, and formed into the cylindrical body.

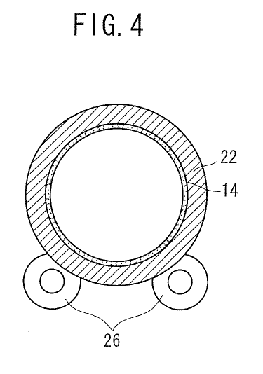

The powder feeder 36 is moved backward in the direction of an arrow X shown in FIG. 3 while introducing the powder P. The powder P is introduced substantially uniformly in the longitudinal direction of the cylindrical mold 22 due to the backward movement, so that the cylindrical body is extended continuously in the height direction. As a result, as shown in FIG. 4, the outer cylindrical body 14 attached to the inner peripheral wall of the cylindrical mold 22 is formed.

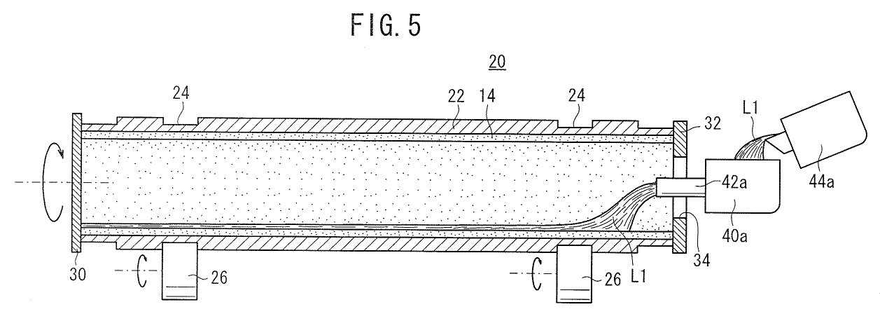

Then, the melt L1 of the Al-23% Si alloy prepared in a melting furnace is transported to the pot 44a, and further transported by tilting the pot 44a to the main body of the trough 40a. Thus, as shown in FIG. 5, the melt L1 is introduced from the melt filling pipe 42a of the trough 40a into the cylindrical mold 22. The introduced melt L1 is spread due to the fluidity toward the discotic closing member 30. It should be noted that the melt L1 is introduced while rotating the cylindrical mold 22.

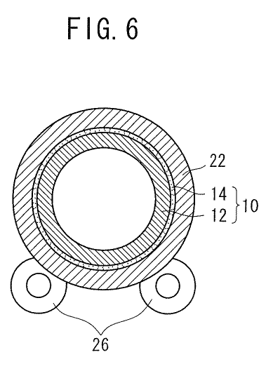

Most of the melt L1 is distributed on the inner peripheral wall of the outer cylindrical body 14 due to a centrifugal force, to form the inner cylindrical body 12 as shown in FIG. 6. Meanwhile, part of the melt L1 penetrates the outer cylindrical body 14. The inner cylindrical body 12 on the outer cylindrical body 14 and the melt L1 penetrating the outer cylindrical body 14 have a high temperature, whereby the powder of the outer cylindrical body 14 is slightly melted to form a liquid phase. When the melt L1 is cooled and solidified, also the liquid phase is cooled and solidified. As a result, the powder particles are fused to each other, so that the toughness of the outer cylindrical body 14 is improved to obtain the hollow member 10.

A spiny of the coating material is transferred onto the outer peripheral wall of the outer cylindrical body 14. Further, the inner peripheral wall of the outer cylindrical body 14 is connected to the outer peripheral wall of the inner cylindrical body 12.

Because the outer cylindrical body 14 acts as a cooling metal (a chiller), the rate of cooling the melt L1 is higher in the first embodiment than in general centrifugal casting methods. Thus, the melt L1 is solidified before primary crystal Si grains grow larger, to form a structure containing fine primary crystal Si grains. The primary crystal Si grains have an average diameter of about 35 μm or less.

Further, because of the higher cooling rate, the melt L1 is solidified before the Si grains in the melt L1 are moved due to a centrifugal force toward the outer peripheral wall. The primary crystal Si grains are prevented from being unevenly distributed, and are dispersed substantially uniformly in the diameter direction of the inner cylindrical body 12. Thus, by using the outer cylindrical body 14 as the chiller, the fine primary crystal Si grains having approximately equal sizes can be uniformly dispersed in the inner cylindrical body 12.

After the annular frame 32 is detached from the end of the cylindrical mold 22, the hollow member 10 having the inner cylindrical body 12 and the outer cylindrical body 14 connected to each other is pulled out together with the coating material from the end. Then, the coating material attached to the outer peripheral wall of the outer cylindrical body 14 is removed by a shot blasting treatment or the like, and a predetermined machining margin is removed by shaving the inner peripheral wall of the inner cylindrical body 12, to obtain a cylinder sleeve having the inner cylindrical body 12, in which the primary crystal Si grains are substantially uniformly dispersed.

The primary crystal Si grains may be slightly unevenly distributed in the formation of the inner cylindrical body 12 by the centrifugal casting, and the amount of the grains may be larger around the outer cylindrical body 14 than inside the radially intermediate portion (around the inner peripheral wall of the inner cylindrical body 12). However, the inner peripheral wall of the hollow member 10 is shaved as described above, so that a portion having a lower Si content is removed as a machining margin. Thus, the resultant cylinder sleeve has a sufficient primary crystal Si grain content.

As described above, in the first embodiment, the hollow member 10, which can be suitably used as a preform for the cylinder sleeve excellent in strength and abrasion resistance, can be produced.

Further, in the first embodiment, the powder is used as a material for forming the outer cylindrical body 14, whereby processes and costs for melting the powder are not required. Also a furnace for melting the powder is not required. Thus, the increase of equipment costs can be prevented, and the hollow member 10 can be produced with reduced costs.

Furthermore, in the first embodiment, the outer cylindrical body 14 acts as a chiller to reduce the primary crystal Si grain size, whereby it is unnecessary to strictly regulate the casting conditions such as the cylindrical mold rotation speed and temperature.

The obtained cylinder sleeve is placed in a cavity of a casting mold for cast-forming a cylinder block for use in an internal combustion engine of an automobile. A melt of aluminum or the like is introduced to the cavity, and cooled and solidified to cast-form the cylinder block. Thus, the cylinder block is cast around the cylinder sleeve, and the internal combustion engine containing such a cylinder sleeve is excellent in durability.

Though the Al-12% Si alloy is used for the powder for forming the outer cylindrical body 14 in the first embodiment, the powder may be composed of Al or another Al alloy. The material of the melt L1 for forming the inner cylindrical body 12 is not limited to the Al-23% Si alloy, and the melt L1 may be composed of any Al—Si alloy.

A second embodiment will be described below. In the second embodiment, a cylindrical cast body is formed using a melt, and then the same type of a melt is introduced into the cylindrical cast body to produce a hollow member.

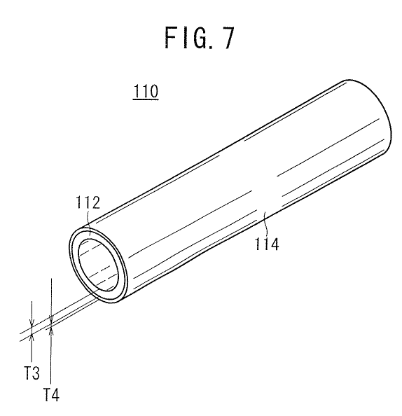

FIG. 7 is an overall, schematic, perspective view showing a preform 110 for forming a cylinder sleeve according to the second embodiment. The preform 110 is a stack of an inner cylindrical body 112 and an outer cylindrical body 114, and is a hollow member having a through hole extending in the longitudinal direction.

In this embodiment, the inner cylindrical body 112 is composed of an Al-17%-23% Si-2.5% Cu alloy (i.e. an A390 equivalent material (JIS, an Al-17% Si alloy) or an AC9A equivalent material (an Al-23% Si alloy)). The inner cylindrical body 112 is a cast body formed by cooling and solidifying a melt as described hereinafter. The inner cylindrical body 112 has a thickness T3 of about 5 to 6 mm.

In the inner cylindrical body 112, fine primary crystal Si grains having an average diameter of 35 μm or less are not unevenly distributed around the outer peripheral wall (in the vicinity of the outer cylindrical body 114), and are dispersed substantially uniformly in the diameter direction. Further, the primary crystal Si grains have a small grain size distribution width. In other words, the fine primary crystal Si grains having approximately equal sizes are uniformly dispersed in the structure of the inner cylindrical body 112.

Also the outer cylindrical body 114 is a cast body composed of an Al-17%-23% Si-2.5% Cu alloy (i.e. an A390 equivalent material or an AC9A equivalent material). Thus, the outer cylindrical body 114 and the inner cylindrical body 112 comprise the same types of the aluminum alloys, and the inner peripheral wall of the outer cylindrical body 114 is connected to the outer peripheral wall of the inner cylindrical body 112. The outer cylindrical body 114 preferably has a thickness T4 of 0.5 to 2.0 mm.

The inner peripheral wall (i.e. the inner cylindrical body 112) of the preform 110 is shaved to produce a cylinder sleeve. In other words, the inner cylindrical body 112 is thinned into a predetermined thickness. Thus, the inner cylindrical body 112 is formed as a machining margin of the preform 110.

As described above, the fine primary crystal Si grains having approximately equal sizes are dispersed uniformly in the diameter direction in the inner cylindrical body 112. Therefore, the inner peripheral wall of the machined preform 110 (the cylinder sleeve), with which a piston is slidably brought into contact, has an excellent abrasion resistance. Further, the machined preform 110 exhibits a high strength over all. Thus, an internal combustion engine containing the cylinder sleeve is excellent in durability.

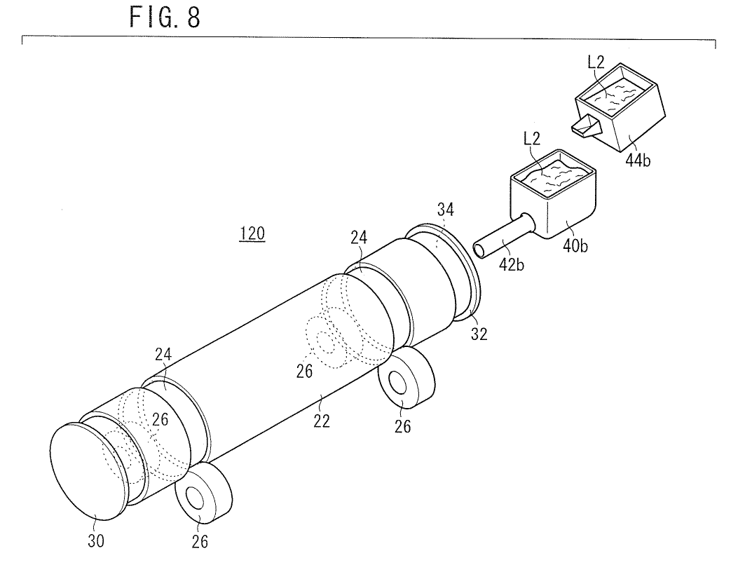

A method for producing the cylinder sleeve using a centrifugal casting machine 120 shown in FIG. 8 will be described below. In FIGS. 2 to 6 and the following drawings, the same components are represented by the same numerals.

The centrifugal casting machine 120 has substantially the same structure as the centrifugal casting machine 20, and contains a cylindrical mold 22 lying approximately horizontally. Two annular grooves 24, 24 are formed on the outer peripheral wall of the cylindrical mold 22 such that the outer peripheral wall is notched along the circumferential direction. The outer peripheral walls of a pair of rollers 26, 26 are slidably in contact with the bottom of each annular groove 24. Thus, the cylindrical mold 22 is supported by two pairs of the rollers. Each of the rollers 26 is rotated by a rotary drive source (not shown), whereby the cylindrical mold 22 is rotated.

A discotic closing member 30 is fitted into one end of the cylindrical mold 22, and an annular frame 32 is attached to the other end. A melt filling pipe 42b of a trough 40b is inserted from a through hole 34 formed in the annular frame 32 into the cylindrical mold 22.

A melt L2 of the Al-17%-23% Si-2.5% Cu alloy for forming the outer cylindrical body 114 and the inner cylindrical body 112 is contained in the main body of the trough 40b. A tiltable pot 44b is disposed in the vicinity of the trough 40b, and the melt L2 is introduced from the pot 44b to the trough 40b.

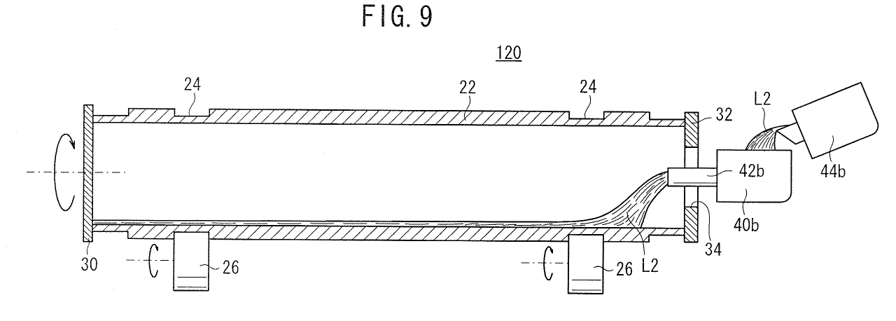

In the production of the cylinder sleeve, the melt L2 of the Al-17%-23% Si-2.5% Cu alloy prepared in a melting furnace is transported to the pot 44b, and further transported by tilting the pot 44b to the main body of the trough 40b. A coating material is applied to the inner peripheral wall of the cylindrical mold 22, and then as shown in FIG. 9, the melt filling pipe 42b of the trough 40b is inserted from the through hole 34 into the cylindrical mold 22.

The rollers 26 are rotated in this state, whereby the cylindrical mold 22 is rotated. Then, a predetermined amount of the melt L2 of the Al-17%-23% Si-2.5% Cu alloy is introduced from the trough 40b into the cylindrical mold 22, and flowed in the longitudinal direction of the cylindrical mold 22. The melt L2 is distributed on the inner peripheral wall of the cylindrical mold 22 due to a centrifugal force into a cylindrical shape, to form the outer cylindrical body 114. In the second embodiment, the melt L2 is supplied in such an amount that the outer cylindrical body 114 has a thickness of 0.5 to 2.0 mm.

A spiny of the coating material is transferred onto the outer peripheral wall of the outer cylindrical body 114 during the formation. The melt L2 of the Al-17%-23% Si-2.5% Cu alloy is further supplied to the pot 44b.

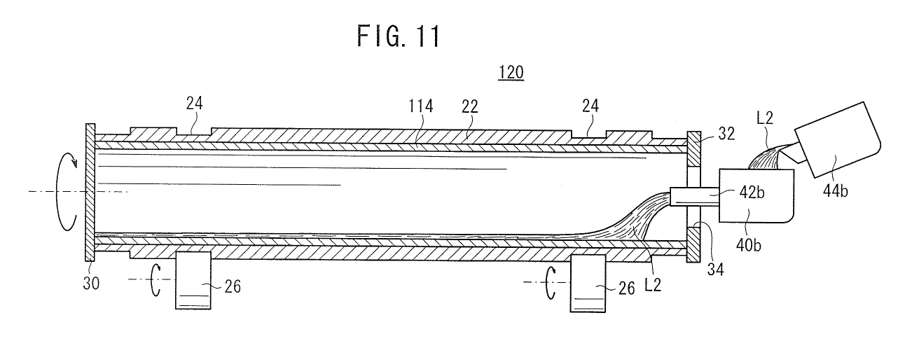

After the introduction of the melt L2 to the cylindrical mold 22 is completed, the melt L2 is transported to the main body of the trough 40b by tilting the pot 44b. The melt L2 is transported immediately after the temperature of the outer cylindrical body 114 is lowered to a liquidus-solidus temperature of a phase diagram or less, for example, preferably immediately after the outer cylindrical body 114 is left under certain conditions for 8 to 25 seconds. Then, as shown in FIG. 11, the melt L2 is introduced from the melt filling pipe 42b of the trough 40b into the cylindrical mold 22. The introduced melt L2 is spread due to the fluidity toward the discotic closing member 30. It should be noted that the melt L2 is introduced while rotating the cylindrical mold 22.

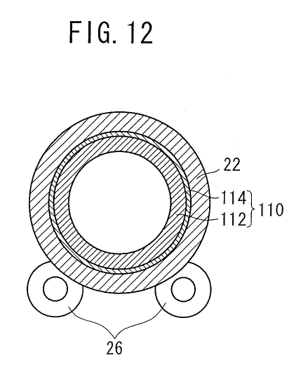

The melt L2 is distributed on the inner peripheral wall of the outer cylindrical body 114 due to a centrifugal force, to form the inner cylindrical body 112 as shown in FIG. 12. In the resultant preform 110, the outer cylindrical body 114 is stacked on the inner cylindrical body 112, and the inner peripheral wall of the outer cylindrical body 114 is connected to the outer peripheral wall of the inner cylindrical body 112.

The outer cylindrical body 114 acts as a cooling metal (a chiller), when the inner cylindrical body 112 is cooled and solidified. Therefore, the rate of cooling the melt L2 is higher in the second embodiment than in general centrifugal casting. Thus, the melt L2 is solidified before primary crystal Si grains grow larger, to form a structure containing fine primary crystal Si grains. The primary crystal Si grains have an average diameter of about 35 μm or less.

Further, because of the higher cooling rate, the melt L2 is solidified before the Si grains in the melt L2 are moved due to a centrifugal force toward the outer peripheral wall. The primary crystal Si grains are prevented from being unevenly distributed, and are dispersed substantially uniformly in the diameter direction of the inner cylindrical body 112. Thus, by using the outer cylindrical body 114 as the chiller, the fine primary crystal Si grains having approximately equal sizes can be uniformly dispersed in the inner cylindrical body 112.

After the annular frame 32 is detached from the end of the cylindrical mold 22, the preform 110 having the inner cylindrical body 112 and the outer cylindrical body 114 connected to each other is pulled out together with the coating material from the end. Then, the coating material attached to the outer peripheral wall of the outer cylindrical body 114 is removed by a shot blasting treatment or the like, and a predetermined machining margin is removed by shaving the inner peripheral wall of the inner cylindrical body 112, to obtain a cylinder sleeve having the inner cylindrical body 112, in which the primary crystal Si grains are substantially uniformly dispersed.

The primary crystal Si grains may be slightly unevenly distributed in the formation of the inner cylindrical body 112 by the centrifugal casting, and the amount of the grains may be larger around the outer cylindrical body 114 than inside the radially intermediate portion (around the inner peripheral wall of the inner cylindrical body 112). However, the inner peripheral wall of the preform 110 is shaved as described above, so that a portion having a lower Si content is removed as a machining margin. Thus, the resultant cylinder sleeve has a sufficient primary crystal Si grain content.

As described above, in the second embodiment, the cylinder sleeve excellent in strength and abrasion resistance can be produced.

Further, in the second embodiment, the outer cylindrical body 114 acts as a chiller to reduce the primary crystal Si grain size, whereby it is unnecessary to strictly regulate the casting conditions such as the cylindrical mold rotation speed and temperature.

The obtained cylinder sleeve is placed in a cavity of a casting mold for cast-forming a cylinder block for use in an internal combustion engine of an automobile. A metal melt for forming the cylinder block is introduced to the cavity. Thus, the cylinder block is cast around the cylinder sleeve to produce the internal combustion engine. When the cylindrical block is cast around the cylindrical sleeve, the spiny on the outer peripheral wall of the cylinder sleeve (the outer cylindrical body 114) acts as an anchor to obtain a sufficient bonding strength between the cylinder sleeve and the cylinder block.

In the internal combustion engine, a piston is slidably brought into contact with the inner peripheral wall of the cylinder sleeve. The inner peripheral wall of the cylinder sleeve is the inner cylindrical body 112 composed of the A390 equivalent material (the Al-17% Si alloy) or the AC9A equivalent material (the Al-23% Si alloy) with a high primary crystal Si grain content as described above, and thereby is excellent in abrasion resistance.

As described above, the cylinder sleeve produced in the second embodiment is excellent in the bonding strength with respect to the cylinder block and in the abrasion resistance of the inner peripheral wall, with which the piston is slidably brought into contact.

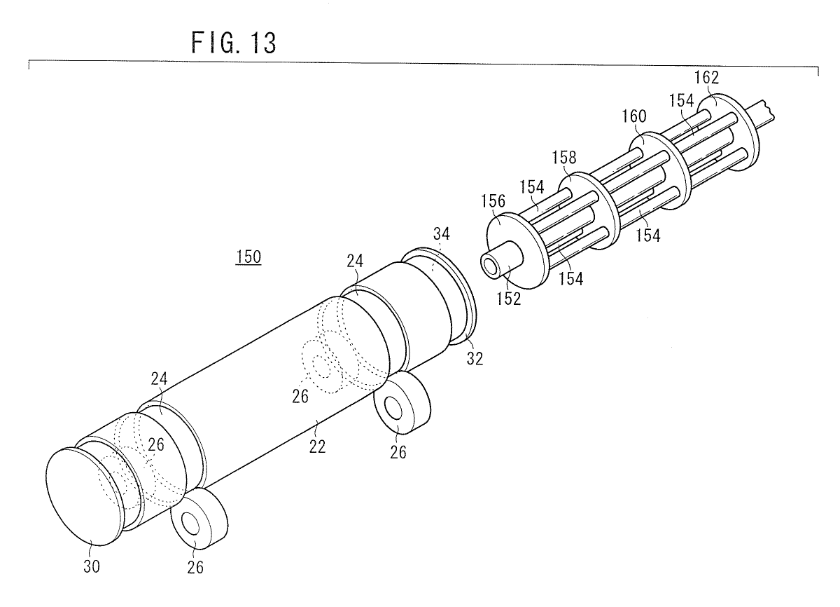

The melt L2 may be introduced into a cylindrical mold 22 of a centrifugal casting machine 150 shown in FIG. 13. This modification example will be described below.

In this example, a melt filling pipe 152 is inserted into a through hole 34 of an annular frame 32. In other words, the melt filling pipe 152 is introduced from the through hole 34 into the cylindrical mold 22.

The melt filling pipe 152 is surrounded by four rod heaters 154. A first sandwiching plate 156, a first insert supporting plate 158, a second insert supporting plate 160, and a second sandwiching plate 162 are positioned and fixed in this order from the tip end of the melt filling pipe 152. The melt filling pipe 152 is inserted in center through holes of the plates, and both ends of each rod heater 154 are sandwiched between the first sandwiching plate 156 and the second sandwiching plate 162. Further, intermediate portions of each rod heater 154 are supported such that the rod heater 154 is inserted in small through holes formed around the center through holes of the first insert supporting plate 158 and the second insert supporting plate 160.

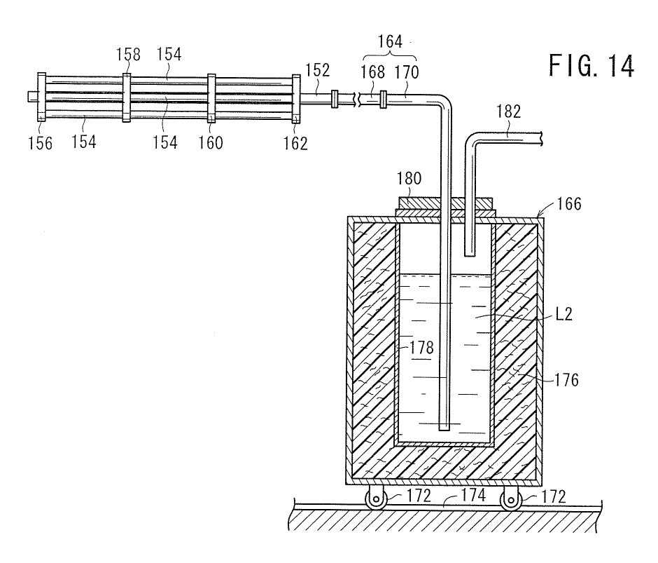

As shown in FIG. 14, the melt filling pipe 152 is connected to a melt storage furnace 166 by a supply pipe 164. Thus, the melt filling pipe 152 and the melt storage furnace 166 are linked by the supply pipe 164 such that a flexible tube 168 extending from the melt filling pipe 152 is connected to a reverse-L-shaped tube 170 having an approximately reverse L shape, and extending from the melt storage furnace 166.

Wheels 172 are disposed at the bottom of the melt storage furnace 166, and each wheel 172 is slidably engaged with a guide rail 174 disposed on a floor of a workstation. Thus, the melt storage furnace 166 is displaced along the guide rail 174 by rotating the wheels 172.

A heat insulating material 176 is disposed in the melt storage furnace 166, and a melt container 178 is surrounded by the heat insulating material 176. An immersion heater (not shown) is inserted into the melt container 178 to heat the melt L2 of the Al-17%-23% Si-2.5% Cu alloy stored in the melt container 178, and the temperature of the heated melt L2 is maintained by the heat insulating material 176.

An opening for introducing the melt is formed in a part of the upper end of the melt container 178. The opening is closed by a cover 180.

The cover 180 has two through holes, and the above-mentioned reverse-L-shaped tube 170 of the supply pipe 164 is inserted in one of the through holes. The end of the reverse-L-shaped tube 170 is immersed in the melt L2. A gas supply pipe 182 extending from an argon gas supply source (not shown) is inserted in the other through hole, and it is disposed at a slight distance from the surface of the melt L2.

In the production of a preform 110 using the centrifugal casting machine 150 having such a structure, a coating material is applied to the inner peripheral wall of the cylindrical mold 22, and then rollers 26 are rotated, whereby the cylindrical mold 22 is rotated. Meanwhile, an argon gas (an inert gas) is introduced from the argon gas supply source through the gas supply pipe 182 into the melt container 178 of the melt storage furnace 166.

In the melt container 178, the melt L2 is under a pressure of the argon gas. By increasing the argon gas pressure, the melt L2 is raised in the reverse-L-shaped tube 170, and transported through the flexible tube 168 to the melt filling pipe 152. In this example, the melt L2 is transported from the melt storage furnace 166 to the cylindrical mold 22 by the inert gas pressure in this manner, so that air and obviously the inert gas are hardly incorporated.

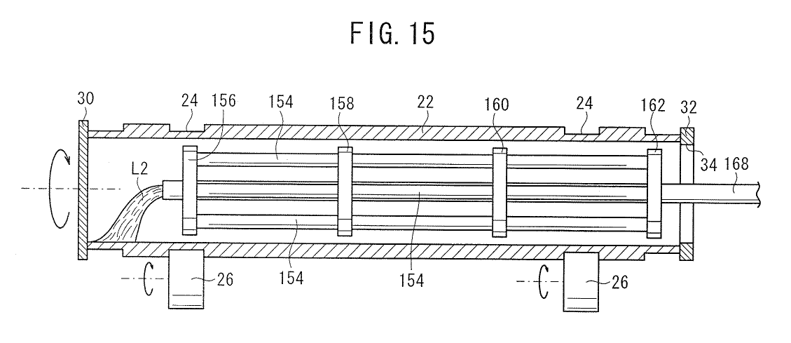

As shown in FIG. 15, the melt filling pipe 152 is inserted into the cylindrical mold 22 such that the end is positioned in the vicinity of a discotic closing member 30. Thus, the melt L2 is supplied in the vicinity of the discotic closing member 30, and then flowed toward the annular frame 32.

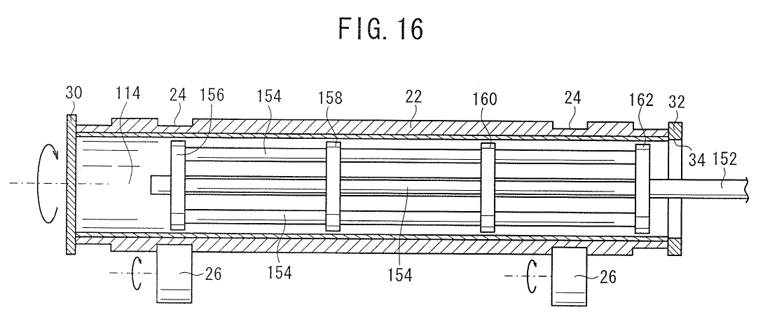

The melt L2 is introduced while rotating the cylindrical mold 22. Thus, as shown in FIG. 16, the melt L2 is distributed on the inner peripheral wall of the cylindrical mold 22 due to a centrifugal force, to form an outer cylindrical body 114. When the melt L2 is introduced in an amount for forming the outer cylindrical body 114 with a thickness of 0.5 to 2.0 mm, the introduction of the melt L2 is stopped once.

Immediately after the temperature of the outer cylindrical body 114 is lowered to a liquidus-solidus temperature of a phase diagram or less, the introduction of the melt L2 is restarted to form an inner cylindrical body 112. The rod heaters 154 are heated prior to the restart of the introduction. For example, the gross heating value of the rod heaters 154 may be about 30 kW.

In this example, the melt L2 is supplied such that the final preform 110 has a thickness of 5 to 6 mm. Thus, the clearance between each rod heater 154 and the inner peripheral wall of the preform 110 is about 5 mm. Even when air or another gas is incorporated into the melt L2, an air bubble (an internal defect) is hardly generated in the preform 110 since the amount of the gas is extremely small as described above. The inventors have confirmed that, when the clearance is 5 mm, the amount of the incorporated gas is extremely slight.

Then, the melt L2 is cooled and solidified while maintaining the melt filling pipe 152 inside the cylindrical mold 22. Since the rod heaters 154 are heated beforehand as described above, the inner peripheral wall of the inner cylindrical body 112 is heated by the rod heaters 154 in the cooling solidification. Meanwhile, the outer peripheral wall of the inner cylindrical body 112 is in contact with the solidified outer cylindrical body 114. Thus, in the inner cylindrical body 112, the cooling rate is higher around the outer peripheral wall than around inner peripheral wall.

The inner cylindrical body 112 has such heat gradient, and it takes a longer time to solidify the inner peripheral wall because the cooling rate is lower at the inner peripheral wall than at the outer peripheral wall. Therefore, even when the argon gas is incorporated into the melt L2 to generate an air bubble, the air bubble can be moved toward the inner peripheral wall.

On the other hand, primary crystal Si grains are prevented from being grown larger and coarsened around the outer peripheral wall because of the higher cooling rate. Thus, in the inner cylindrical body 112 of this example, fine primary crystal Si grains are dispersed around the outer peripheral wall, and defects are concentrated around the inner peripheral wall.

Then, a force is applied to the melt storage furnace 166, whereby the melt storage furnace 166 is displaced along the guide rail 174 away from the cylindrical mold 22. The wheels 172 at the bottom of the melt storage furnace 166 are rotated in this step.

The melt filling pipe 152 and the rod heaters 154 are brought out from the cylindrical mold 22 according to the above displacement of the melt storage furnace 166. The melt storage furnace 166 is moved to and stopped in a melt supply station, and the melt L2 is supplied to the melt container 178.

After the annular frame 32 is detached from the end of the cylindrical mold 22, the preform 110 is pulled out together with the coating material from the end. Then, the outer peripheral wall of the preform 110 is subjected to a shot blasting treatment or the like to remove the coating material, and the inner peripheral wall of the preform 110 is shaved such that the inner peripheral wall having the concentrated defects is removed and the outer peripheral wall having the substantially uniformly dispersed fine primary crystal Si grains remains. Thus obtained cylinder sleeve has a remarkably small number of internal defects and a high fine primary crystal Si grain content, and thereby is excellent in strength and abrasion resistance. A concavo-convex shape on the coating material is transferred onto the outer peripheral wall of the cylinder sleeve to form a spiny.

In the case of using Al-17%-23% Si-2.5% Cu alloys for the inner cylindrical body 112 and the outer cylindrical body 114, the compositions of the alloys do not have to be strictly the same. The A390 equivalent material is an aluminum alloy containing 17% to 18% of Si. For example, an A390 equivalent material containing 17% of Si and an A390 equivalent material containing 18% of Si may be used for the outer cylindrical body 114 and the inner cylindrical body 112 respectively.

Though the A390 equivalent material or the AC9A equivalent material is used for the inner cylindrical body 112 and the outer cylindrical body 114 of the cylinder sleeve in the second embodiment, the materials of the cylindrical bodies are not particularly limited and may be selected from the other aluminum alloys such as ADC10 (JIS) and ADC12 (JIS).

The thickness T4 of the outer cylindrical body 114 is not limited to 0.5 to 2.0 mm, and may be selected in view of controlling the rate of cooling the inner cylindrical body 112 to obtain a desired structure.

A third embodiment will be described below. In the third embodiment, a hollow member is produced by adding a melt inside a cylindrical formed body to form a cylindrical cast body.

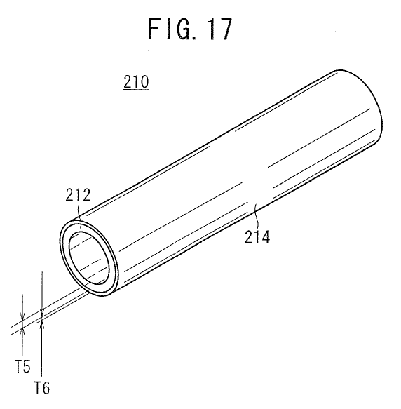

FIG. 17 is an overall, schematic, perspective view showing a preform 210 for forming a cylinder sleeve according to the third embodiment. The preform 210 is a stack of an inner cylindrical cast body 212 and an outer cylindrical formed body 214, and is a hollow member having a through hole extending in the longitudinal direction.

In this embodiment, the inner cylindrical cast body 212 is a cast body composed of an Al-23% Si alloy. The inner cylindrical cast body 212 is formed by cooling and solidifying a melt as described hereinafter. The inner cylindrical cast body 212 has a thickness T5 of about 5 to 6 mm.

In the inner cylindrical cast body 212, fine primary crystal Si grains having an average diameter of 35 μm or less are evenly distributed around the outer peripheral wall (in the vicinity of the outer cylindrical formed body 214), and are dispersed substantially uniformly in the diameter direction. Further, the primary crystal Si grains have a small grain size distribution width. In other words, the fine primary crystal Si grains having approximately equal sizes are uniformly dispersed in the structure of the inner cylindrical cast body 212.

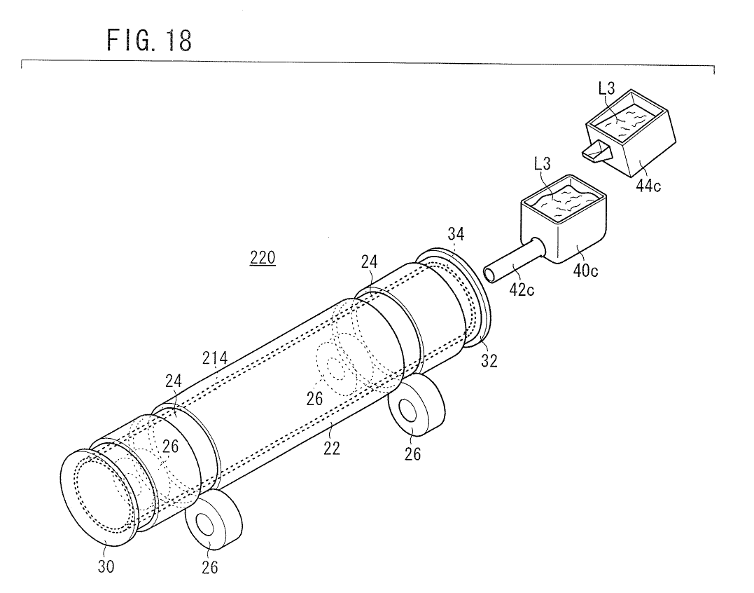

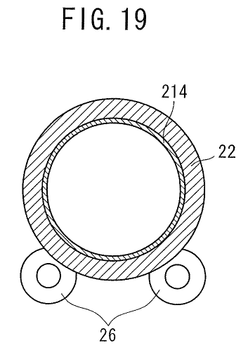

On the other hand, the outer cylindrical formed body 214 is composed of an Al-11% Si-2.5% Cu alloy (ADC12) or the like. The inner peripheral wall of the outer cylindrical formed body 214 is connected to the outer peripheral wall of the inner cylindrical cast body 212. As shown in FIGS. 18 and 19, the outer cylindrical formed body 214 is inserted in a cylindrical mold 22 of a centrifugal casting machine 220 before forming the inner cylindrical cast body 212. The outer cylindrical formed body 214 preferably has a thickness T6 of 1.0 to 2.0 mm.

The inner peripheral wall (i.e. the inner cylindrical cast body 212) of the preform 210 is shaved to produce the cylinder sleeve. In other words, the inner cylindrical cast body 212 is thinned into a predetermined thickness. Thus, the inner cylindrical cast body 212 is formed as a machining margin of the preform 210.

As described above, the fine primary crystal Si grains having approximately equal sizes are dispersed uniformly in the diameter direction in the inner cylindrical cast body 212. Therefore, the inner peripheral wall of the machined preform 210 (the cylinder sleeve), with which a piston is slidably brought into contact, has an excellent abrasion resistance. Further, the machined preform 210 exhibits a high strength over all. Thus, an internal combustion engine containing the cylinder sleeve is excellent in durability.

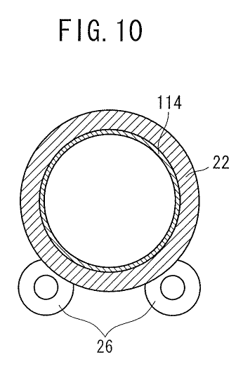

A method for producing the cylinder sleeve using the centrifugal casting machine 220 shown in FIG. 18 will be described below. In FIGS. 2 to 6, FIGS. 8 to 12, and the following drawings, the same components are represented by the same numerals.

The centrifugal casting machine 220 has substantially the same structure as the centrifugal casting machines 20, 120, and contains the cylindrical mold 22 lying approximately horizontally. Two annular grooves 24, 24 are formed on the outer peripheral wall of the cylindrical mold 22 such that the outer peripheral wall is notched along the circumferential direction.

The outer peripheral walls of a pair of rollers 26, 26 are slidably in contact with the bottom of each annular groove 24. Thus, each of the rollers 26 is rotated by a rotary drive source (not shown), whereby the cylindrical mold 22 is rotated.

A discotic closing member 30 is fitted into one end of the cylindrical mold 22, and an annular frame 32 is attached to the other end. A melt filling pipe 42c of a trough 40c is inserted from a through hole 34 formed in the annular frame 32 into the cylindrical mold 22.

A melt L3 of the Al-23% Si alloy for forming the inner cylindrical cast body 212 is contained in the main body of the trough 40c. A tiltable pot 44c is disposed in the vicinity of the trough 40c, and the melt L3 is introduced from the pot 44c to the trough 40c.

In the production of the cylinder sleeve, an ADC12 cylinder (i.e. the outer cylindrical formed body 214) is inserted in the cylindrical mold 22 as shown in FIGS. 18 and 19. The outer diameter of the outer cylindrical formed body 214 corresponds to the inner diameter of the cylindrical mold 22, whereby the outer cylindrical formed body 214 and the cylindrical mold 22 are hardly distanced.

The rollers 26 are rotated in this state, whereby the cylindrical mold 22 is rotated. The looseness between the outer cylindrical formed body 214 and the cylindrical mold 22 is remarkably small as described above, and the outer cylindrical formed body 214 is not vibrated in the cylindrical mold 22.

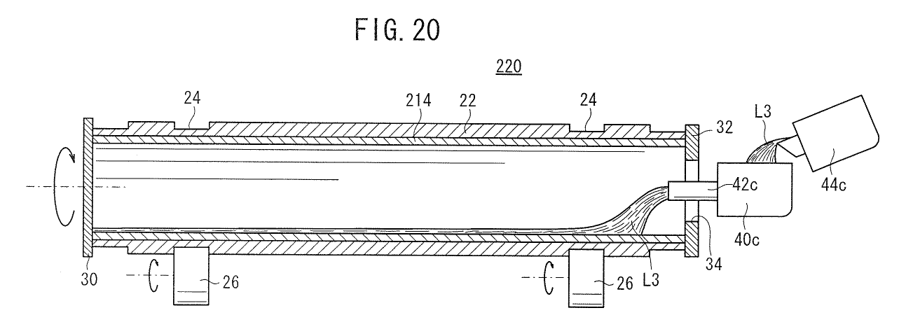

Then, as shown in FIG. 20, the melt filling pipe 42c of the trough 40c is inserted from the through hole 34 into the cylindrical mold 22. The melt L3 of the Al-23% Si alloy prepared in a melting furnace is transported to the pot 44c, and further transported by tilting the pot 44c to the main body of the trough 40c. A predetermined amount of the Al-23% Si alloy melt L3 is introduced from the trough 40c into the outer cylindrical formed body 214, and flowed in the longitudinal direction toward the discotic closing member 30. The melt L3 is distributed on the inner peripheral wall of the outer cylindrical formed body 214 due to a centrifugal force into a cylindrical shape, to form the inner cylindrical cast body 212. In the third embodiment, the amount of the melt L3 supplied is adjusted such that the inner cylindrical cast body 212 has a thickness of 5 to 6 mm.

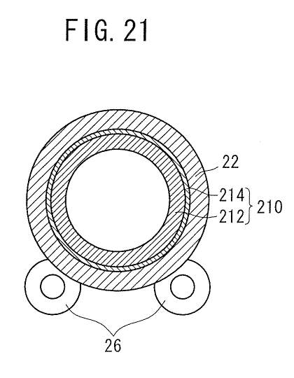

The inner cylindrical cast body 212 is formed in this manner as shown in FIG. 21. In thus obtained preform 210, the outer cylindrical formed body 214 is stacked on the inner cylindrical cast body 212, and the inner peripheral wall of the outer cylindrical formed body 214 is connected to the outer peripheral wall of the inner cylindrical cast body 212.

The outer cylindrical formed body 214 acts as a cooling metal (a chiller) when inner cylindrical cast body 212 is cooled and solidified. Therefore, the rate of cooling the melt L3 is higher in the third embodiment than in common centrifugal casting methods. Thus, the melt L3 is solidified before primary crystal Si grains grow larger, to form a structure containing fine primary crystal Si grains. In the third embodiment, the thickness T6 of the outer cylindrical formed body 214 being 1.0 to 2.0 mm, the primary crystal Si grains have an average diameter of about 35 μm or less.

Further, because of the high cooling rate, the melt L3 is solidified before the Si grains in the melt L3 are moved due to a centrifugal force toward the outer peripheral wall. The primary crystal Si grains are prevented from being unevenly distributed, and are dispersed substantially uniformly in the diameter direction of the inner cylindrical cast body 212. Thus, by using the outer cylindrical formed body 214 as the chiller, the fine primary crystal Si grains having approximately equal sizes can be uniformly dispersed in the inner cylindrical cast body 212.

After the annular frame 32 is detached from the end of the cylindrical mold 22, the preform 210 having the inner cylindrical cast body 212 and the outer cylindrical formed body 214 connected to each other is pulled out together with the coating material from the end. Then, the outer peripheral wall of the outer cylindrical formed body 214 is subjected to a shot blasting treatment or the like to form a fine concavo-convex shape, and a predetermined machining margin is removed by shaving the inner peripheral wall of the inner cylindrical cast body 212, to obtain a cylinder sleeve having the inner cylindrical cast body 212, in which the primary crystal Si grains are substantially uniformly dispersed.

The primary crystal Si grains may be slightly unevenly distributed in the formation of the inner cylindrical cast body 212 by the centrifugal casting, and the amount of the grains may be larger around the outer cylindrical formed body 214 than inside the radially intermediate portion (around the inner peripheral wall of the inner cylindrical cast body 212). However, the inner peripheral wall of the preform 210 is shaved as described above, so that a portion having a lower Si content is removed as a machining margin. Thus, the resultant cylinder sleeve has a sufficient primary crystal Si grain content.

As described above, in the third embodiment, the cylinder sleeve excellent in strength and abrasion resistance can be produced.

Further, in the third embodiment, the outer cylindrical formed body 214 acts as a chiller to reduce the primary crystal Si grain size, whereby it is unnecessary to strictly regulate the casting conditions such as the cylindrical mold rotation speed and temperature.

The obtained cylinder sleeve is placed in a cavity of a casting mold for cast-forming a cylinder block for use in an internal combustion engine of an automobile. A melt of an ADC12 or the like for forming the cylinder block is introduced to the cavity.

Thus, the cylinder block is cast around the cylinder sleeve to produce the internal combustion engine. In this step, the concavo-convex shape on the outer peripheral wall of the cylinder sleeve (the outer cylindrical formed body 214) acts as an anchor. The cylinder block and the outer cylindrical formed body 214 are composed of the ADC12, and they have the same linear expansion coefficient. The cylinder sleeve and the cylinder block are expanded and shrunk to approximately the same extent in the introduction and the cooling solidification of the metal melt. Therefore, the cylinder block is hardly peeled off from the cylinder sleeve, and a sufficient bonding strength can be maintained only by the anchor effect of the concavo-convex shape between the cylinder sleeve and the cylinder block.

In the internal combustion engine, a piston is slidably brought into contact with the inner peripheral wall of the cylinder sleeve. The inner peripheral wall of the cylinder sleeve is the inner cylindrical cast body 212 composed of the Al-23% Si alloy with a high primary crystal Si grain content as described above, and thereby is significantly excellent in abrasion resistance. Thus, the internal combustion engine is excellent in durability.

As described above, the cylinder sleeve produced in the third embodiment is excellent in the strength of bonding to the cylinder block and the abrasion resistance of the inner peripheral wall, with which the piston is slidably brought into contact.

Though the ADC12 is used for the outer cylindrical formed body 214 of the cylinder sleeve in the third embodiment, the material of the outer cylindrical formed body 214 is not particularly limited and may be a material equal to the Al-23% Si alloy of the inner cylindrical cast body 212, another aluminum alloy such as an ADC10, or aluminum.

The material of the inner cylindrical cast body 212 is not limited to the Al-23% Si alloy, and may be an ADC10 or an ADC12.

The thickness T6 of the outer cylindrical formed body 214 is not limited to 1.0 to 2.0 mm, and may be selected in view of controlling the rate of cooling the inner cylindrical cast body 212 to obtain a desired structure.

Further, though the cylinder sleeve is illustrated as the hollow member in the above first to third embodiments, the hollow member is not limited thereto and may be any member.

A fourth embodiment will be described finally. In a cylinder sleeve according to the fourth embodiment, the outer periphery and the inner periphery are composed of types of different materials.

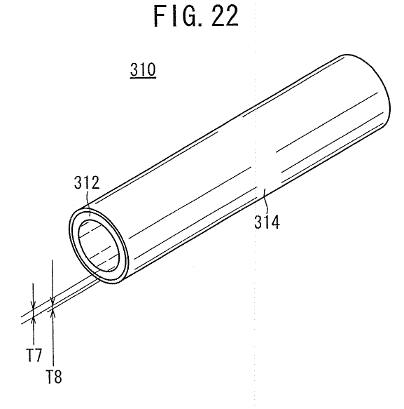

FIG. 22 is an overall, schematic, perspective view showing a preform 310 for forming a cylinder sleeve according to the fourth embodiment. The preform 310 is a stack of an inner cylindrical body 312 and an outer cylindrical body 314.

In this embodiment, the inner cylindrical body 312 is composed of an Al-17%-23% Si-2.5% Cu alloy (i.e. an A390 equivalent material (an Al-17% Si alloy) or an AC9A equivalent material (an Al-23% Si alloy)). The inner cylindrical body 312 is a cast body formed by cooling and solidifying a melt as described hereinafter. The inner cylindrical body 312 has a thickness T7 of about 5 to 6 mm.

In the inner cylindrical body 312, fine primary crystal Si grains having an average diameter of 35 μm or less are evenly distributed around the outer peripheral wall (in the vicinity of the outer cylindrical body 314), and are dispersed substantially uniformly in the diameter direction. Further, the primary crystal Si grains have a small grain size distribution width. In other words, the fine primary crystal Si grains having approximately equal sizes are uniformly dispersed in the structure of the inner cylindrical body 312.

On the other hand, the outer cylindrical body 314 is a cast body composed of an Al-11% Si-2.5% Cu alloy (ADC12). Also the outer cylindrical body 314 is formed by cooling and solidifying a melt, and the inner peripheral wall of the outer cylindrical body 314 is connected to the outer peripheral wall of the inner cylindrical body 312. The outer cylindrical body 314 preferably has a thickness T8 of 0.5 to 2.0 mm.

The inner peripheral wall (i.e. the inner cylindrical body 312) of the preform 310 is shaved to produce the cylinder sleeve. In other words, the inner cylindrical body 312 is thinned into a predetermined thickness. Thus, the inner cylindrical body 312 is formed as a machining margin of the preform 310.

As described above, the fine primary crystal Si grains having approximately equal sizes are dispersed uniformly in the diameter direction in the inner cylindrical body 312. Therefore, the inner peripheral wall of the machined preform 310 (the cylinder sleeve), with which a piston is slidably brought into contact, has an excellent abrasion resistance. Further, the machined preform 310 exhibits a high strength over all. Thus, an internal combustion engine containing the cylinder sleeve is excellent in durability.

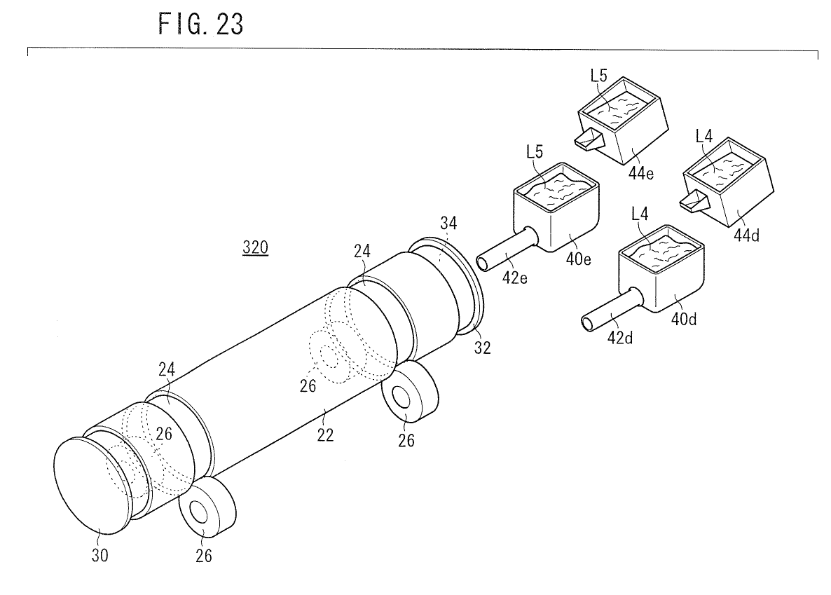

A method for producing the cylinder sleeve using a centrifugal casting machine 320 shown in FIG. 23 will be described below.

The centrifugal casting machine 320 has substantially the same structure as the centrifugal casting machines 20, 120, 220. The centrifugal casting machine 320 contains a cylindrical mold 22 lying approximately horizontally, two annular grooves 24, 24 formed on the outer peripheral wall of the cylindrical mold 22, and rollers 26, 26 slidably in contact with the annular grooves 24, 24. Each roller 26 is rotated, whereby the cylindrical mold 22 is rotated. Further, a discotic closing member 30 is fitted into one end of the cylindrical mold 22, and an annular frame 32 having a through hole 34 is attached to the other end, in the same manner as above.

In the fourth embodiment, two troughs 40d, 40e and two pots 44d, 44e are used. A melt filling pipe 42d of the trough 40d or a melt filling pipe 42e of the trough 40e is inserted from the through hole 34 into the cylindrical mold 22.

A melt L4 of the ADC12 for forming the outer cylindrical body 314 is contained in the main body of the trough 40d. The tiltable pot 44d is disposed in the vicinity of the trough 40d, and the melt L4 is introduced from the pot 44d to the trough 40d.

On the other hand, a melt L5 for forming the inner cylindrical body 14 is contained in the main body of the trough 40e. The tiltable pot 44e is disposed in the vicinity of the trough 40e, and the melt L5 is introduced from the pot 44e to the trough 40e.

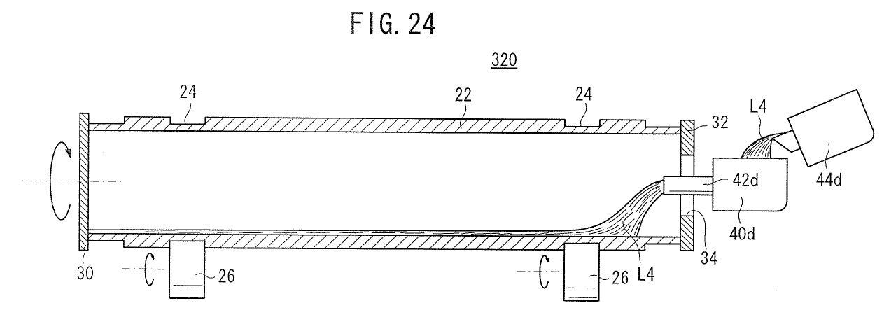

In the production of the preform 310 for the cylinder sleeve, the ADC12 melt L4 prepared in a melting furnace is transported to the pot 44d, and further transported by tilting the pot 44d to the main body of the trough 40d. Meanwhile, a coating material is applied to the inner peripheral wall of the cylindrical mold 22, and then as shown in FIG. 24, the melt filling pipe 42d of the trough 40d is inserted from the through hole 34 into the cylindrical mold 22. Though the melt filling pipe 42e of the trough 40e is not shown in FIG. 24, the melt filling pipe 42e may be positioned such that it does not interfere the trough 40d.

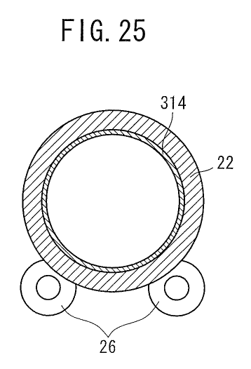

The rollers 26 start rotating in this state, so that the cylindrical mold 22 is rotated. Then, a predetermined amount of the ADC12 melt L4 is introduced from the trough 40d into the cylindrical mold 22, and flowed in the longitudinal direction of the cylindrical mold 22. The melt L4 is distributed on the inner peripheral wall of the cylindrical mold 22 due to a centrifugal force into a cylindrical shape, to form the outer cylindrical body 314 as shown in FIG. 25. In the fourth embodiment, the amount of the melt L4 supplied is adjusted such that the outer cylindrical body 314 has a thickness of 0.5 to 2.0 mm.

A spiny of the coating material is transferred onto the outer peripheral wall of the outer cylindrical body 314 during the formation thereof.

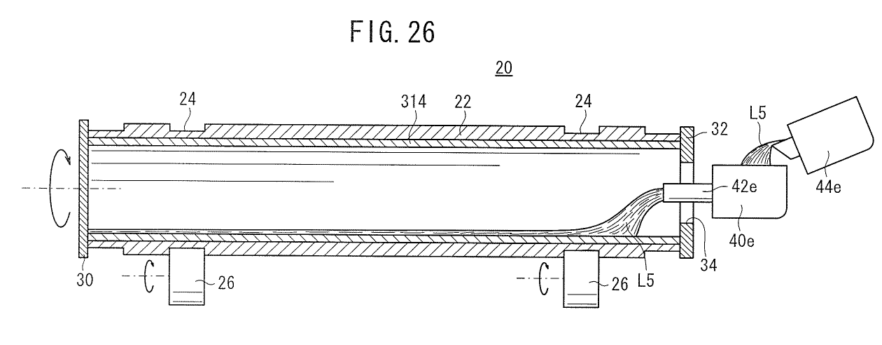

The melt L5 of the A390 equivalent material (the Al-17% Si alloy) or the AC9A equivalent material (the Al-23% Si alloy) prepared in a melting furnace is transported to the pot 44e, and further transported by tilting the pot 44e to the main body of the trough 40e immediately after the temperature of the outer cylindrical body 314 is lowered to a liquidus-solidus temperature of a phase diagram or less, for example, preferably immediately after the outer cylindrical body 314 is left under certain conditions for 8 to 25 seconds. Then, as shown in FIG. 26, the melt L5 is introduced from the melt filling pipe 42e of the trough 40e into the cylindrical mold 22. The introduced melt L5 is spread due to the fluidity toward the discotic closing member 30. The melt L5 is introduced while rotating the cylindrical mold 22.

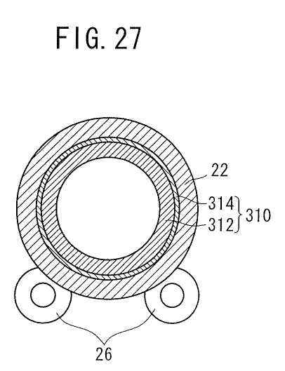

The melt L5 is distributed on the inner peripheral wall of the outer cylindrical body 314 due to a centrifugal force, to form the inner cylindrical body 312 as shown in FIG. 27. In the resultant preform 310, the outer cylindrical body 314 is stacked on the inner cylindrical body 312, and the inner peripheral wall of the outer cylindrical body 314 is connected to the outer peripheral wall of the inner cylindrical body 312.

The outer cylindrical body 314 acts as a cooling metal (a chiller) when the inner cylindrical body 312 is cooled and solidified. Therefore, the rate of cooling the melt L5 is higher in the fourth embodiment than in general centrifugal casting methods. Thus, the melt L5 is solidified before primary crystal Si grains grow larger, to form a structure containing fine primary crystal Si grains. The primary crystal Si grains have an average diameter of about 35 μm or less.

Further, because of the high cooling rate, the melt L5 is solidified before the Si grains in the melt L5 are moved due to a centrifugal force toward the outer peripheral wall. The primary crystal Si grains are prevented from being unevenly distributed, and are dispersed substantially uniformly in the diameter direction of the inner cylindrical body 312. Thus, by using the outer cylindrical body 314 as the chiller, the fine primary crystal Si grains having approximately equal sizes can be uniformly dispersed in the inner cylindrical body 312.

After the annular frame 32 is detached from the end of the cylindrical mold 22, the preform 310 having the inner cylindrical body 312 and the outer cylindrical body 314 connected to each other is pulled out together with the coating material from the end. Then, the coating material attached to the outer peripheral wall of the outer cylindrical body 314 is removed by a shot blasting treatment or the like, and a predetermined machining margin is removed by shaving the inner peripheral wall of the inner cylindrical body 312, to obtain a cylinder sleeve having the inner cylindrical body 312, in which the primary crystal Si grains are substantially uniformly dispersed.

The primary crystal Si grains may be slightly unevenly distributed in the formation of the inner cylindrical body 312 by the centrifugal casting, and the amount of the grains may be larger around the outer cylindrical body 314 than inside the radially intermediate portion (around the inner peripheral wall of the inner cylindrical body 312). However, the inner peripheral wall of the preform 310 is shaved as described above, so that a portion having a lower Si content is removed as a machining margin. Thus, the resultant cylinder sleeve has a sufficient primary crystal Si grain content.

As described above, in the fourth embodiment, the cylinder sleeve excellent in strength and abrasion resistance can be produced.

Further, in the fourth embodiment, the outer cylindrical body 314 acts as a chiller to reduce the primary crystal Si grain size, whereby it is unnecessary to strictly regulate the casting conditions such as the cylindrical mold rotation speed and temperature.

The obtained cylinder sleeve is placed in a cavity of a casting mold for cast-forming a cylinder block for use in an internal combustion engine of an automobile. A metal melt for forming the cylinder block is introduced to the cavity.

In this embodiment, the metal melt is composed of aluminum or an Al-9% Si-3% Cu alloy (an ADC10 or an ADC12). The linear expansion coefficient of the aluminum, ADC10, or ADC12 is approximately the same as that of the ADC12 of the outer cylindrical body 314. The cylinder sleeve and the cylinder block are expanded and shrunk to approximately the same extent in the introduction and the cooling solidification of the metal melt. Therefore, a sufficient bonding strength between the cylinder sleeve and the cylinder block can be maintained by the anchor effect of the spiny transferred onto the outer peripheral wall of the outer cylindrical body 314. Thus, the cylinder block is cast around the cylinder sleeve to produce the internal combustion engine.

In the internal combustion engine, a piston is slidably brought into contact with the inner peripheral wall of the cylinder sleeve. The inner peripheral wall of the cylinder sleeve is the inner cylindrical body 312 composed of the A390 equivalent material or the AC9A equivalent material with a high primary crystal Si grain content as described above, and thereby is significantly excellent in abrasion resistance. Thus, the internal combustion engine is excellent in durability.

As described above, the cylinder sleeve produced in the fourth embodiment is excellent in the strength of bonding to the cylinder block and in the abrasion resistance of the inner peripheral wall, with which the piston is slidably brought into contact.

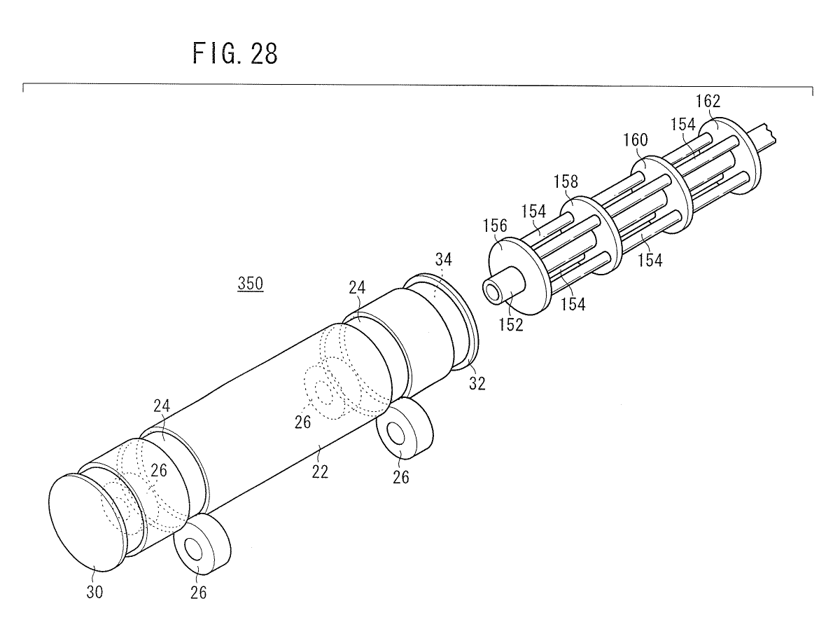

The inner cylindrical body 312 may be formed by using a centrifugal casting machine 350, which has the same structure as the centrifugal casting machine 150 used in the modification example of the second embodiment. This modification example will be described below with reference to FIGS. 28 to 31. In FIGS. 13 to 16 and FIGS. 28 to 31, the same components are represented by the same numerals, and duplicate explanations therefor are omitted.

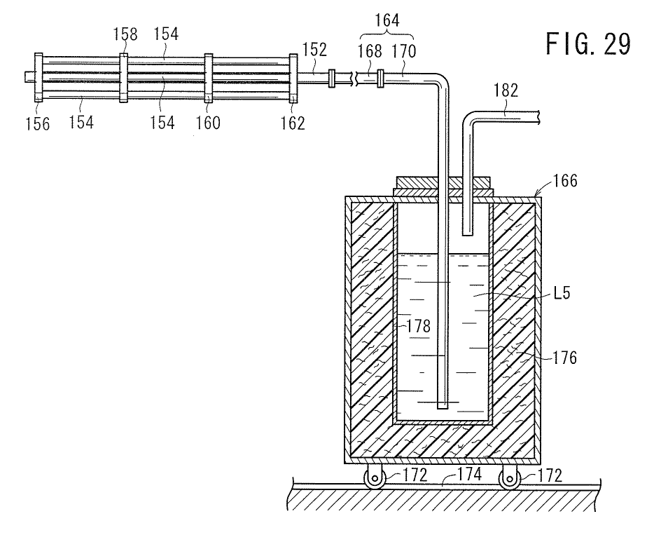

As shown in FIGS. 28 and 29, the centrifugal casting machine 350 of this example has a structure according to the modification example of the second embodiment as mentioned above, and is operated in the same manner as in the modification example. First a coating material is applied to the inner peripheral wall of a cylindrical mold 22 in the centrifugal casting machine 150, and then rollers 26 are rotated, whereby the cylindrical mold 22 is rotated. Then, a melt filling pipe 42d of a trough 40d is inserted from a through hole 34 into the cylindrical mold 22, and a melt L4 of an ADC12 is added therefrom. After a predetermined amount of the melt L4 is added, the melt filling pipe 42d of the trough 40d is moved backward to the outside of the cylindrical mold 22.

Immediately after the temperature of the outer cylindrical body 314 is lowered to a liquidus-solidus temperature of a phase diagram or less, an argon gas (an inert gas) is introduced from an argon gas supply source through a gas supply pipe 182 into a melt container 178 of a melt storage furnace 166.

In the melt container 178, the melt L5 is under a pressure of the argon gas. By increasing the argon gas pressure, the melt L5 is raised in a reverse-L-shaped tube 170, and transported through a flexible tube 168 to a melt filling pipe 152. In this example, the melt L5 is transported from the melt storage furnace 166 to the cylindrical mold 22 by the inert gas pressure in this manner, so that air and obviously the inert gas are hardly incorporated.

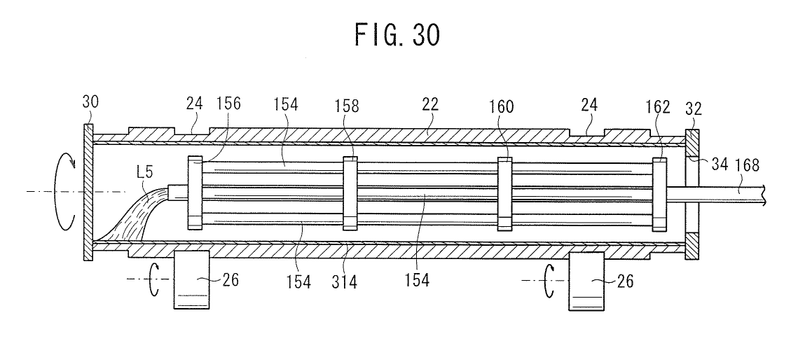

As shown in FIG. 30, the melt filling pipe 152 is inserted into the cylindrical mold 22 such that the end is positioned in the vicinity of a discotic closing member 30. Thus, the melt L5 is supplied in the vicinity of the discotic closing member 30, and then flowed toward an annular frame 32.

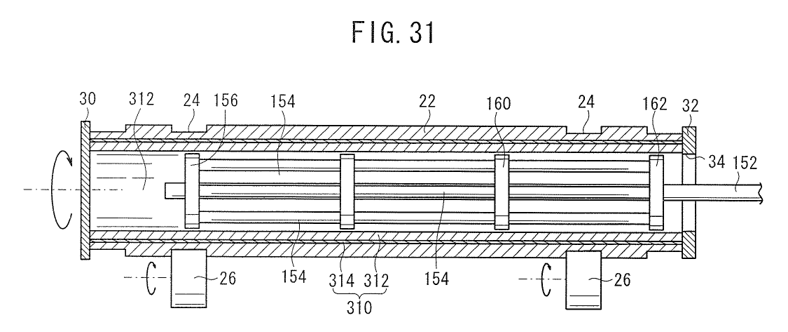

The melt L5 is introduced while rotating the cylindrical mold 22. Thus, as shown in FIG. 31, the melt L5 is distributed on the inner peripheral wall of the outer cylindrical body 314 due to a centrifugal force, to form the inner cylindrical body 312. Rod heaters 154 are heated prior to the introduction of the melt L5. For example, the gross heating value of the rod heaters 154 may be about 30 kW.

In this example, the melt L5 is supplied such that the final preform 310 has a thickness of 5 to 6 mm. Thus, the clearance between each rod heater 154 and the inner peripheral wall of the preform 310 is about 5 mm. Even when air or another gas is incorporated into the melt L5, an air bubble (an internal defect) is hardly generated in the preform 310 since the amount of the gas is extremely small as described above. The inventors have confirmed that, when the clearance is 5 mm, the amount of the incorporated gas is extremely slight.

Then, the melt L5 is cooled and solidified while maintaining the melt filling pipe 152 inside the cylindrical mold 22. Since the rod heaters 154 are heated beforehand as described above, the inner peripheral wall of the inner cylindrical body 312 is heated by the rod heaters 154 in the cooling solidification. Meanwhile, the outer peripheral wall of the inner cylindrical body 312 is in contact with the solidified outer cylindrical body 314. Thus, in the inner cylindrical body 312, the cooling rate is higher around the outer peripheral wall than around inner peripheral wall.

The inner cylindrical body 312 has such heat gradient, and it takes a longer time to solidify the inner peripheral wall at the lower cooling rate, compared with the outer peripheral wall. Therefore, even when the argon gas is incorporated into the melt L5 to generate an air bubble, the air bubble can be moved toward the inner peripheral wall.

On the other hand, primary crystal Si grains are prevented from being grown larger and coarsened around the outer peripheral wall because of the higher cooling rate thereof. Thus, in the inner cylindrical body 312 of this example, fine primary crystal Si grains are dispersed around the outer peripheral wall, and defects are concentrated around the inner peripheral wall.

Then, a force is applied to the melt storage furnace 166, whereby the melt storage furnace 166 is displaced along a guide rail 174 away from the cylindrical mold 22. Wheels 172 at the bottom of the melt storage furnace 166 are rotated in this step.

The melt filling pipe 152 and the rod heaters 154 are brought out from the cylindrical mold 22 according to the above displacement of the melt storage furnace 166. The melt storage furnace 166 is moved to and stopped in a melt supply station, and the melt L5 is supplied to the melt container 178.

After the annular frame 32 is detached from the end of the cylindrical mold 22, the preform 310 is pulled out together with the coating material from the end. Then, the outer peripheral wall of the preform 310 is subjected to a shot blasting treatment or the like to remove the coating material, and the inner peripheral wall of the preform 310 is shaved such that the inner peripheral wall having the concentrated defects is removed and the outer peripheral wall having the substantially uniformly dispersed fine primary crystal Si grains remains. Thus obtained cylinder sleeve has a remarkably small number of internal defects and a high fine primary crystal Si grain content, and thereby is excellent in strength and abrasion resistance. A concavo-convex shape on the coating material is transferred onto the outer peripheral wall of the cylinder sleeve to form a spiny.

Though the cylinder block is composed of aluminum, the ADC10, or the ADC12, and the outer cylindrical body 314 is composed of the ADC12 in the fourth embodiment, the material of the outer cylindrical body 314 capable of obtaining a sufficient bonding strength is not limited thereto. The material of the outer cylindrical body 314 may be any material as long as the linear expansion coefficient difference between the outer cylindrical body 314 and the cylinder block is 3×10⁻⁶/° C. or less. Further, of course the cylinder block and the outer cylindrical body 314 may be composed of the same aluminum alloy.

The material of the inner cylindrical body 312 is not limited to the A390 equivalent material (the Al-17% Si alloy) or the AC9A equivalent material (the Al-23% Si alloy), and may be any Al—Si alloy as long as it is more abrasion-resistant than the Al—Si alloy of the outer cylindrical body 314.

Further, the material of the inner cylindrical body 312 is not limited to a high-abrasion-resistant material, and the material of the outer cylindrical body 314 is not limited to a material having a linear expansion coefficient similar to that of the cylinder block. The materials may be appropriately selected depending on desired properties.

Furthermore, the thickness T8 of the outer cylindrical body 314 is not limited to 0.5 to 2.0 mm, and may be selected in view of controlling the rate of cooling the inner cylindrical body 312 to obtain a desired structure.

1. A substantially cylindrical, stack-type, hollow member comprising an outer cylindrical body and an inner cylindrical body connected to an inner peripheral wall thereof, wherein said outer cylindrical body is formed by fusing a powder of aluminum or an aluminum alloy, and said inner cylindrical body is composed of an Al—Si alloy.

2. A hollow member according to claim 1, wherein said outer cylindrical body is composed of an Al—Si alloy.

3. A method for producing a substantially cylindrical, stack-type, hollow member by centrifugal casting by supplying a melt into a cylindrical mold rotating, comprising the steps of:
introducing a powder of aluminum or an aluminum alloy into the rotating cylindrical mold to form an outer cylindrical body; and
introducing the melt of an Al—Si alloy onto an inner peripheral wall of said outer cylindrical body, thereby fusing said powder and forming an inner cylindrical body of said melt, to produce a hollow member containing a stack of said outer cylindrical body and said inner cylindrical body connected to said inner peripheral wall thereof.

4. A method according to claim 3, wherein said powder for forming said outer cylindrical body is introduced into said cylindrical mold while rotating said cylindrical mold at a G number (G No.) of 30 or more.

5. A method according to claim 3, wherein said outer cylindrical body is composed of an Al—Si alloy.

6. A substantially cylindrical, stack-type, hollow member comprising an outer cylindrical body and an inner cylindrical body disposed in this order from an outside thereof, wherein said inner cylindrical body and said outer cylindrical body are composed of the same types of Al—Si alloys.

7. A hollow member according to claim 6, wherein primary crystal Si grains in a metal structure have an average diameter of 35 μm or less.

8. A hollow member according to claim 6, wherein said hollow member is a cylinder sleeve to be disposed in a bore of a cylinder block of an internal combustion engine.

9. A method for producing a substantially cylindrical, stack-type, hollow member by centrifugal casting by supplying a melt into a cylindrical mold rotating, comprising the steps of:
introducing a melt of an Al—Si alloy into a cylindrical mold rotating, thereby forming an outer cylindrical body by centrifugal casting; and
introducing a melt of the same type of an Al—Si alloy as of the melt into said outer cylindrical body while rotating said cylindrical mold, thereby forming an inner cylindrical body by centrifugal casting, to prepare a stacked preform.

10. A method according to claim 9, wherein said outer cylindrical body has a thickness of 0.5 to 2.0 mm, and said melt for forming said inner cylindrical body is introduced after the temperature of said outer cylindrical body is lowered to a liquidus-solidus temperature of a phase diagram or less.

11. A method according to claim 9, further comprising the step of shaving an inner peripheral wall of said preform to produce a cylinder sleeve to be disposed in a bore of a cylinder block of an internal combustion engine.

12. A substantially cylindrical, stack-type, hollow member comprising an inner cylindrical cast body and an outer cylindrical formed body disposed in this order from an inside thereof, wherein said inner cylindrical cast body comprises aluminum or an aluminum alloy, and said outer cylindrical formed body is composed of an Al—Si alloy.

13. A hollow member according to claim 12, wherein primary crystal Si grains in a metal structure of said inner cylindrical cast body have an average diameter of 35 μm or less.

14. A hollow member according to claim 12, wherein said hollow member is a cylinder sleeve to be disposed in a bore of a cylinder block of an internal combustion engine.

15. A method for producing a substantially cylindrical, stack-type, hollow member containing a stack of an inner cylindrical cast body and an outer cylindrical formed body disposed in this order from an inside thereof, comprising the steps of:
inserting a cylinder of aluminum or an aluminum alloy for forming said outer cylindrical formed body into a cylindrical mold of a centrifugal casting machine; and
introducing a melt of an Al—Si alloy into said cylindrical mold rotating, thereby forming said inner cylindrical cast body by centrifugal casting, to prepare a stacked preform.

16. A method according to claim 15, wherein said cylinder for forming said outer cylindrical formed body has a thickness of 1.0 to 2.0 mm.

17. A method according to claim 15, further comprising the step of shaving an inner peripheral wall of said preform to produce a cylinder sleeve to be disposed in a bore of a cylinder block of an internal combustion engine.

18. A cylinder sleeve to be disposed in a bore of a cylinder block of an internal combustion engine, comprising an outer cylindrical body and an inner cylindrical body disposed in this order from an outside thereof, wherein said inner cylindrical body and said outer cylindrical body are composed of different types of Al—Si alloys.

19. A cylinder sleeve according to claim 18, wherein said Al—Si alloy of said inner cylindrical body is more abrasion-resistant than that of said outer cylindrical body.

20. A cylinder sleeve according to claim 18, wherein the linear expansion coefficient difference between said Al—Si alloy of said outer cylindrical body and a material of said cylinder block is 3×10⁻⁶/° C. or less.

21. A cylinder sleeve according to claim 18, wherein a concavo-convex shape is formed on an outer peripheral wall of said outer cylindrical body.

22. A method for producing a cylinder sleeve to be disposed in a bore of a cylinder block of an internal combustion engine, comprising the steps of:
introducing a first melt of an Al—Si alloy into a cylindrical mold rotating, thereby forming an outer cylindrical body by centrifugal casting;
introducing a second melt of another type of Al—Si alloy into said outer cylindrical body while rotating said cylindrical mold, thereby forming an inner cylindrical body by centrifugal casting, to prepare a stacked preform; and
shaving an inner peripheral wall of said preform.

23. A method according to claim 22, wherein said Al—Si alloy of said second melt (L5) is more abrasion-resistant than that of said first melt.

24. A method according to claim 22, wherein a material for said first melt is selected such that the linear expansion coefficient difference between the cylinder sleeve formed of said first melt and a material of said cylinder block is 3×10⁻⁶/° C. or less.
